(19) United States
(12) Patent Application Publication
(10) Pub. No.: US 2026/0347001 A1
(43) Pub. Date: Nov. 5, 2026

(54) SYSTEMS, APPARATUSES, METHODS, AND COMPUTER PROGRAM PRODUCTS FOR PERFORMING ONE OR MORE CYBER THREAT RESPONSIVE ACTIONS

(71) Applicant: Honeywell International Inc., Charlotte, NC (US)

(72) Inventors: Kirupakar JANAKIRAMAN, Phoenix, AZ (US); Nayyar RAO, Phoenix, AZ (US); Angelo KOUTSOGIANNIS, Phoenix, AZ (US); Kalimulla KHAN, Bangalore (IN); Kantha CHIKKEGOWDA, Bangalore (IN)

(21) Appl. No.: 19/662,664

(22) Filed: Apr. 29, 2026

Related U.S. Application Data
(60) Provisional application No. 63/797,661, filed on Apr. 30, 2025.

(51) Int. Cl. B64D 45/00; G06F 21/55

(52) U.S. Cl. CPC B64D 45/0018; G06F 21/554

(57) ABSTRACT

Systems, apparatuses, methods, and computer program products are provided herein. For example, a method described herein comprises receiving, at an onboard aircraft cyber threat operations device, an aircraft cyber threat detection model from a cloud-based aircraft cyber threat operations device. In some embodiments, the method comprises identifying, using the onboard aircraft cyber threat operations device, an aircraft operational feature from a first aircraft component of one or more aircraft components of an aircraft. In some embodiments, the method comprises detecting, using the onboard aircraft cyber threat operations device, an aircraft cyber threat event by applying the aircraft operational feature to the aircraft cyber threat detection model. In some embodiments, the method comprises performing, using the onboard aircraft cyber threat operations device and based on the aircraft cyber threat event, one or more aircraft cyber threat responsive actions.

### CROSS-REFERENCE TO RELATED APPLICATIONS

This application claims priority U.S. Provisional Application No. 63/797,661, titled SYSTEMS, APPARATUSES, METHODS, AND COMPUTER PROGRAM PRODUCTS FOR PERFORMING ONE OR MORE CYBER THREAT RESPONSIVE ACTIONS, filed Apr. 30, 2025, which is hereby incorporated by reference in its entirety.

### TECHNOLOGICAL FIELD

Embodiments of the present disclosure relate generally to systems, apparatuses, methods, and computer program products for performing one or more cyber threat responsive actions.

### BACKGROUND

Applicant has identified many technical challenges and difficulties associated with systems, apparatuses, methods, and computer program products for aircraft cybersecurity. Through applied effort, ingenuity, and innovation, Applicant has solved problems related to systems, apparatuses, methods, and computer program products for aircraft cybersecurity by developing solutions embodied in the present disclosure, which are described in detail below.

### BRIEF DESCRIPTION OF FIGURES

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates an example block diagram of an environment in which embodiments of the present disclosure may operate;

FIG. 2 illustrates an example block diagram of an example apparatus that may be specially configured in accordance with an example embodiment of the present disclosure;

FIG. 3 illustrates an architecture in accordance with one or more embodiments of the present disclosure;

FIG. 4 illustrates an interface in accordance with one or more embodiments of the present disclosure;

FIG. 5 illustrates a flowchart of an example method in accordance with one or more embodiments of the present disclosure;

FIG. 6 illustrates a flowchart of an example method in accordance with one or more embodiments of the present disclosure;

FIG. 7 illustrates a flowchart of an example method in accordance with one or more embodiments of the present disclosure; and

FIG. 8 illustrates a flowchart of an example method in accordance with one or more embodiments of the present disclosure.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The use of the term “circuitry” as used herein with respect to components of a system, or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communication circuitry, input/output circuitry, and the like. In some embodiments, other elements may provide or supplement the functionality of particular circuitry. Alternatively, or additionally, in some embodiments, other elements of a system and/or apparatus described herein may provide or supplement the functionality of another particular set of circuitry. For example, a processor may provide processing functionality to any of the sets of circuitry, a memory may provide storage functionality to any of the sets of circuitry, communications circuitry may provide network interface functionality to any of the sets of circuitry, and/or the like.

### Overview

Example embodiments disclosed herein address technical problems associated with aircraft cybersecurity. In this regard, for example, as would be understood by one skilled in the field to which this disclosure pertains, there are numerous example scenarios in which it may be desirable to enable aircraft cybersecurity. For example, it may be desirable to enable aircraft cybersecurity in order to detect and/or respond to cyber threats targeting one and/or more aircraft components during an aircraft mission performed by an aircraft.

Example solutions for enabling aircraft cybersecurity comprise using a computing device to enable aircraft cybersecurity. However, such example solutions are inefficient, technically deficient, suffer from high latency, reactive, simplistic, and/or inflexible. For example, such example solutions are inefficient because such example solutions do not leverage the resources of the cloud to generate and/or train an aircraft cyber threat detection model that is then deployed to an aircraft to detect aircraft cyber threat events based on aircraft operational features. In this regard, for example, such example solutions are unable to dynamically and/or intelligently identify cyber threats targeting aircraft components during an aircraft mission. For example, such example solutions are simplistic because such example solutions do not leverage machine learning and/or artificial intelligence techniques to analyze patterns in communication traffic on an aircraft bus to detect anomalous data packets, unauthorized command sequences, and/or unexpected data transmission frequencies. In this regard, for example, such example solutions are unable to distinguish between routine operational variations and/or actual cyber threat events. For example, such example solutions are inflexible because such example solutions do not implement aircraft cyber threat responsive actions that cause affected aircraft components to enter a safe operational mode while maintaining operations that enable the aircraft to aviate, navigate, and/or communicate. In this regard, for example, such example solutions are unable to automatically invalidate compromised data on an aircraft bus and/or activate backup aircraft components to maintain operational continuity. For example, such example solutions are technically deficient because such example solutions are unable to automatically implement aircraft cyber threat responsive actions autonomously and/or in real-time during an aircraft mission. In this regard, for example, such example solutions are unable to respond to cyber threats without manual intervention, which limits the effectiveness and/or timeliness of threat mitigation. For example, such example solutions suffer from high latency because such example solutions use inefficient computing techniques for preparing and/or implementing detection of a cyber threat event. Accordingly, there is a need for systems, apparatuses, methods, and/or computer program products for enabling aircraft cybersecurity in an efficient, technically sufficient, and/or low latency manner.

Thus, to address these and/or other issues related to such example solutions, example systems, apparatuses, methods, and/or computer program products for performing one and/or more aircraft cyber threat responsive actions are disclosed herein. For example, an embodiment in this disclosure, described in greater detail below, comprises a method that comprises receiving, at an onboard aircraft cyber threat operations device, an aircraft cyber threat detection model from a cloud-based aircraft cyber threat operations device. In some embodiments, the aircraft cyber threat detection model is trained by the cloud-based aircraft cyber threat operations device. In some embodiments, the method comprises accessing, using the onboard aircraft cyber threat operations device, a real-time aircraft operational feature from a first aircraft component of one and/or more aircraft components of an aircraft. In some embodiments, a real-time aircraft operational feature is representative of real-time operations of the first aircraft component while the aircraft is performing an aircraft mission. In some embodiments, the method comprises detecting, using the onboard aircraft cyber threat operations device, an aircraft cyber threat event by applying a real-time aircraft operational feature to the aircraft cyber threat detection model. In some embodiments, the method comprises performing, using the onboard aircraft cyber threat operations device and/or based on the aircraft cyber threat event, one and/or more aircraft cyber threat responsive actions. Accordingly, the systems, apparatuses, methods, and/or computer program products disclosed herein enable aircraft cybersecurity in an efficient, technically sufficient, and/or low latency manner.

### Example Systems and Apparatuses

Embodiments of the present disclosure herein include systems, apparatuses, methods, and computer program products configured for performing one or more aircraft cyber threat responsive actions. It should be readily appreciated that the embodiments of the apparatus, systems, methods, and computer program product described herein may be configured in various additional and alternative manners in addition to those expressly described herein.

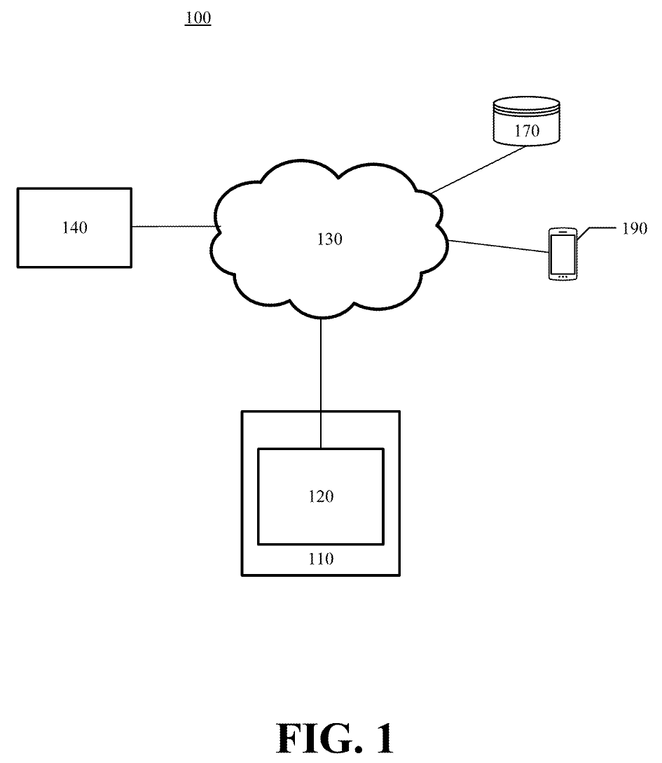

FIG. 1 illustrates an example block diagram of an environment 100 in which embodiments of the present disclosure may operate. Specifically, FIG. 1 illustrates an aircraft 110. In some embodiments, the aircraft 110 may describe any machine, robot, computing devices, and/or apparatus comprised of hardware, software, firmware, and/or any combination thereof, that maneuvers throughout an environment through a medium, such as air. In some contexts, the aircraft 110 is utilized to transport objects, entities (e.g., people, animals, or other beings), and/or other onboard cargo. In some situations, the aircraft 110 may be transporting no object except for the aircraft itself. Examples of the aircraft 110 include airplanes, helicopters, unmanned aerial vehicles (e.g., drones), an urban air mobility (UAM) system and/or the like. In some embodiments, the aircraft 110 is not limited to the examples listed herein and may include other types of transportation device. In some embodiments, the aircraft 110 is configured to travel at a supersonic speed.

In some embodiments, the aircraft 110 is associated with a determinable location. The determinable location of the aircraft 110 in some embodiments represents an absolute position (e.g., GPS coordinates, latitude and longitude locations, an address, and/or the like) or a relative position of the aircraft 110 (e.g., an identifier representing the location of the aircraft 110 as compared to one or more other aircraft, one or more buildings (e.g., an airport), an enterprise headquarters, or general description in the world for example based at least in part on continent, state, ocean, or other definable region). In some embodiments, the aircraft 110 includes or otherwise is associated with a location sensor and/or software-driven location services that provide the location data corresponding to the aircraft 110. In other embodiments, the location of the aircraft 110 is stored and/or otherwise determinable to one or more systems.

In some embodiments, the aircraft 110 and/or one or more other aircraft is configured to perform an aircraft mission. In some embodiments, an aircraft mission is a defined series of operations performed by the aircraft 110. For example, an aircraft mission may include a defined series of operations performed by the aircraft 110 to move from a first airport (e.g., a first vertiport) to a second airport (e.g., a second vertiport). As another example, an aircraft mission may include a defined series of operations performed by the aircraft 110 to move from a home location (e.g., a docking station of a UAV) to a destination (e.g., a package drop off location), from a destination location to a home location, and/or from a first destination location to a second destination location. In this regard, in some embodiments, an aircraft mission may comprise the aircraft 110 performing preflight procedures, (e.g., at the gate before a flight, at a home location of a UAV, etc.), leaving a gate or home location or destination location, taxiing, taking off (e.g., a visual-assisted automatic landing), climbing, cruising (e.g., a cruise phase between takeoff and landing where the aircraft 110 is at a cruise altitude), descending, landing (e.g., a visual-assisted automatic landing), parking at a gate or a destination location or home location, performing post flight procedures (e.g., at the gate after a flight, at a destination location, etc.), and/or the like. For example, an aircraft mission may include a defined series of operations that includes leaving the gate at a first airport or a docking station at a home location, taxiing to a runway at the first airport (e.g., an originating airport), taking off from the first airport or the home location, climbing (e.g., to a cruising altitude), flying or cruising (e.g., at a cruise altitude) to a second airport (e.g., a destination airport) or a destination location, descending (e.g., from a cruising altitude), landing at the second airport or a destination location, taxiing to a gate at the second airport or a destination location, and/or parking at a gate at the second airport or at a destination location. Said differently, for example, an aircraft mission may include a variety of phases such as a preflight procedure phase, a taxi phase, a takeoff phase, a climb phase, a cruise phase, a descent phase, a post flight procedure phase, and/or the like.

In some embodiments, the environment 100 includes a cloud-based aircraft cyber threat operations device 140. In some embodiments, the cloud-based aircraft cyber threat operations device 140 is electronically and/or communicatively coupled to the aircraft 110, an onboard aircraft cyber threat operations device 120, one or more user devices 190, one or more backup aircraft components 306, an aircraft bus 302, and/or one or more aircraft components 304. The cloud-based aircraft cyber threat operations device 140 may be located remotely from the aircraft 110. In some embodiments, the cloud-based aircraft cyber threat operations device 140 comprises a server, a computing system, a distributed computing system, and/or data center equipment. For example, the cloud-based aircraft cyber threat operations device 140 may comprise one or more servers and/or computing systems located at an airline operations center, a maintenance facility, a third-party service provider facility, and/or one or more geographically distributed data centers. Additionally, or alternatively, in some embodiments, the cloud-based aircraft cyber threat operations device 140 comprises a plurality of computing devices configured to operate in a coordinated manner to provide cloud-based services. In this regard, for example, the cloud-based aircraft cyber threat operations device 140 may be located in a remote cloud server and electronically and/or communicatively coupled to the aircraft 110, one or more user devices 190, the onboard aircraft cyber threat operations device 120, one or more backup aircraft components 306, an aircraft bus 302, and/or the one or more aircraft components 304 via at least the network 130. In some embodiments, the cloud-based aircraft cyber threat operations device 140 is configured via hardware, software, firmware, and/or a combination thereof, to perform data intake of one or more types of data.

Additionally, or alternatively, in some embodiments, the cloud-based aircraft cyber threat operations device 140 is configured via hardware, software, firmware, and/or a combination thereof, to generate and/or transmit command(s) that control, adjust, or otherwise impact operations of one or more of the aircraft 110, the onboard aircraft cyber threat operations device 120, one or more user devices 190, one or more backup aircraft components 306, an aircraft bus 302, and/or the one or more aircraft components 304. For example, the cloud-based aircraft cyber threat operations device 140 may be configured to deploy an aircraft cyber threat detection model to the onboard aircraft cyber threat operations device 120. Additionally, or alternatively, in some embodiments, the cloud-based aircraft cyber threat operations device 140 is configured via hardware, software, firmware, and/or a combination thereof, to perform data reporting, provide data, and/or other data output process(es) associated with monitoring or otherwise analyzing operations of one or more of the aircraft 110, the onboard aircraft cyber threat operations device 120, one or more user devices 190, one or more backup aircraft components 306, an aircraft bus 302, and/or the one or more aircraft components 304. For example, in various embodiments, the cloud-based aircraft cyber threat operations device 140 may be configured to execute and/or perform one or more operations and/or functions described herein.

In some embodiments, the environment 100 includes the onboard aircraft cyber threat operations device 120. In some embodiments, the onboard aircraft cyber threat operations device 120 is electronically and/or communicatively coupled to the aircraft 110, the cloud-based aircraft cyber threat operations device 140, one or more user devices 190, one or more backup aircraft components 306, an aircraft bus 302, and/or the one or more aircraft components 304. The onboard aircraft cyber threat operations device 120 may be located remotely from the aircraft 110 (e.g., in a control tower at an airport), in proximity of the aircraft (e.g., with a pilot at an airport gate associated with the aircraft), and/or within the aircraft 110 (e.g., with the pilot in the aircraft). In some embodiments, the onboard aircraft cyber threat operations device 120 is a modular data gateway. In some embodiments, the onboard aircraft cyber threat operations device 120 is configured via hardware, software, firmware, and/or a combination thereof, to perform data intake of one or more types of data. In some embodiments, the onboard aircraft cyber threat operations device 120 is an edge device. Additionally, or alternatively, in some embodiments, the onboard aircraft cyber threat operations device 120 comprises an embedded computing device, a ruggedized computing system, an aircraft gateway device (e.g., an aircraft data gateway), an avionics computer, a dedicated cybersecurity appliance, and/or an integrated circuit board. For example, the onboard aircraft cyber threat operations device 120 may be located in an avionics bay, a cockpit, an electronics equipment bay, behind a flight deck panel, and/or integrated with existing avionics equipment of the aircraft 110. In some embodiments, the onboard aircraft cyber threat operations device 120 is physically secured within the aircraft 110 to withstand environmental conditions associated with aircraft operations.

Additionally, or alternatively, in some embodiments, the onboard aircraft cyber threat operations device 120 is configured via hardware, software, firmware, and/or a combination thereof, to generate and/or transmit command(s) that control, adjust, or otherwise impact operations of one or more of the aircraft 110, the cloud-based aircraft cyber threat operations device 140, one or more user devices 190, one or more backup aircraft components 306, an aircraft bus 302, and/or the one or more aircraft components 304. For example, the onboard aircraft cyber threat operations device 120 may be configured to perform one or more cyber threat responsive actions. Additionally, or alternatively, in some embodiments, the onboard aircraft cyber threat operations device 120 is configured via hardware, software, firmware, and/or a combination thereof, to perform data reporting, provide data, and/or other data output process(es) associated with monitoring or otherwise analyzing operations of one or more of the aircraft 110, the cloud-based aircraft cyber threat operations device 140, one or more user devices 190, one or more backup aircraft components 306, an aircraft bus 302, and/or the one or more aircraft components 304. For example, in various embodiments, the onboard aircraft cyber threat operations device 120 may be configured to execute and/or perform one or more operations and/or functions described herein.

In some embodiments, the environment 100 includes one or more user devices 190. In some embodiments, the one or more user devices 190 are electronically and/or communicatively coupled to the aircraft 110, the cloud-based aircraft cyber threat operations device 140, the one or more aircraft components 304, one or more backup aircraft components 306, an aircraft bus 302, and/or the onboard aircraft cyber threat operations device 120. In various embodiments, the cloud-based aircraft cyber threat operations device 140 and/or the onboard aircraft cyber threat operations device 120 may generate and/or transmit a message, alert, or indication to a user via a user device 190. Additionally, or alternatively, a user device 190 may be utilized by a user to remotely access the cloud-based aircraft cyber threat operations device 140 and/or the onboard aircraft cyber threat operations device 120. This may be by, for example, an application operating on the user device 190. A user may access the cloud-based aircraft cyber threat operations device 140 and/or the onboard aircraft cyber threat operations device 120 remotely, including one or more visualizations, reports, and/or real-time displays.

In some embodiments, the environment 100 includes the one or more aircraft components 304. In some embodiments, the one or more aircraft components 304 are electronically and/or communicatively coupled to the aircraft 110, the cloud-based aircraft cyber threat operations device 140, one or more user devices 190, one or more backup aircraft components 306, an aircraft bus 302, and/or the onboard aircraft cyber threat operations device 120. The one or more aircraft components 304 may be located within the aircraft 110. In this regard, for example, the one or more aircraft components 304 may be one or more individual components of the aircraft that perform a particular function during operation of the aircraft 110. For example, the one or more aircraft components 304 may comprise one or more of a multi-function control and display unit (MCDU), a flight management system (FMS), an inertial reference system (IRS), a sensor, an actuator, a primary flight display, a radar (e.g., a weather radar), an engine, an auxiliary power unit (APU), an enhanced ground proximity warning system (EGPWS), a satellite navigation system, cabin lighting, a video system, a battery component, an obstacle detection component, a hydraulic component, an electrical component, a control surface (e.g., a rudder, an aileron, a primary control surface, an elevator, flaps, spoilers, slats, and/or the like), a communication component, an image capture device, a situation awareness component (e.g., a traffic alert and collision avoidance system (TCAS), a terrain avoidance and warning system (TAWS), and/or the like), an aircraft satellite communications terminal, a multi-mode digital radio, a cockpit speaker, a crew alerting system (CAS), a flight crew alerting system (FCAS), an aircraft communications addressing and reporting system (ACARS), a line replaceable unit (LRU), a quick access recorder (QAR), an air traffic services unit (ATSU), a communication management unit (CMU), a memory card, a flight data recorder (FDR), a cockpit voice recorder (CVR), an autopilot system, an autothrottle system, a navigation display, an electronic centralized aircraft monitor (ECAM), an engine indicating and crew alerting system (EICAS), a global positioning system (GPS) receiver, a very high frequency (VHF) radio, a high frequency (HF) radio, a transponder, an automatic dependent surveillance-broadcast (ADS-B) system, a fuel quantity indication system, a landing gear system, a brake control system, an environmental control system (ECS), a pressurization system, an oxygen system, a fire detection and suppression system, an ice protection system, a stall warning system, a flight control computer (FCC), an air data computer (ADC), a radio altimeter, an electric propulsion unit, a battery management system (BMS), an electric motor controller, a distributed electric propulsion (DEP) system, a vertical takeoff and landing (VTOL) control system, a tilt rotor mechanism, a vertiport communication system, a detect and avoid (DAA) system, a remote pilot interface module, a geofencing module, an urban airspace management interface, a passenger information display system, a noise monitoring system, an electric power distribution unit, a regenerative braking system, a rotor pitch control system, a fly-by-wire flight control system, a lidar-based obstacle detection system, a vehicle-to-vehicle (V2V) communication system, a vehicle-to-infrastructure (V2I) communication system, an autonomous navigation controller, a waypoint management system, a cargo delivery management system, a MAVLink-compatible bus interface, a DroneCAN bus interface, a UAVCAN bus interface, a return-to-home module, and/or the like. In some embodiments, the one or more aircraft components 304 are operated by an aircraft manufacturer, an avionics provider, an airline, a maintenance provider, and/or other entity associated with aircraft operations. In some embodiments, the one or more aircraft components 304 may be located within the aircraft 110 and/or on an exterior surface of the aircraft 110. For example, the one or more aircraft components 304 may be located in a cockpit, a fuselage, a wing, an empennage, an engine nacelle, and/or a landing gear bay of the aircraft 110. In some embodiments, the one or more aircraft components 304 generate data associated with operations of the aircraft 110 and/or receive commands from other aircraft systems. In this regard, for example, the individual aircraft components 304 of the aircraft 110 may comprise components associated with a particular process and/or operation performed by the aircraft 110. In some embodiments, the one or more aircraft components 304 are physically secured to the aircraft 110.

In some embodiments, the one or more aircraft components 304 are configured via hardware, software, firmware, and/or a combination thereof, to perform data intake of one or more types of data. Additionally, or alternatively, in some embodiments, the one or more aircraft components 304 is configured via hardware, software, firmware, and/or a combination thereof, to generate and/or transmit command(s) that control, adjust, or otherwise impact operations of one or more of the aircraft 110, the cloud-based aircraft cyber threat operations device 140, one or more user devices 190, one or more backup aircraft components 306, an aircraft bus 302, and/or the onboard aircraft cyber threat operations device 120. For example, the one or more aircraft components 304 may be configured to perform one or more cyber threat responsive actions. Additionally, or alternatively, in some embodiments, the one or more aircraft components 304 are configured via hardware, software, firmware, and/or a combination thereof, to perform data reporting, provide data, and/or other data output process(es) associated with monitoring or otherwise analyzing operations of one or more of the aircraft 110, the cloud-based aircraft cyber threat operations device 140, one or more backup aircraft components 306, an aircraft bus 302, one or more user devices 190, and/or the onboard aircraft cyber threat operations device 120. For example, in various embodiments, the one or more aircraft components 304 may be configured to execute and/or perform one or more operations and/or functions described herein. In some embodiments, the one or more of the one or more aircraft components 304 is a line replaceable unit (LRU). For example, a first aircraft component of the one or more aircraft components 304 is a first line replaceable unit.

In some embodiments, the environment 100 includes the one or more backup aircraft components 306. In some embodiments, the one or more backup aircraft components 306 are electronically and/or communicatively coupled to the aircraft 110, the cloud-based aircraft cyber threat operations device 140, one or more user devices 190, one or more aircraft components 304, an aircraft bus 302, and/or the onboard aircraft cyber threat operations device 120. The one or more backup aircraft components 306 may be located within the aircraft 110. In this regard, for example, the one or more backup aircraft components 306 may be one or more individual components of the aircraft that perform a particular function during operation of the aircraft 110. For example, the one or more backup aircraft components 306 may comprise one or more of a multi-function control and display unit (MCDU), a flight management system (FMS), an inertial reference system (IRS), a sensor, an actuator, a primary flight display, a radar (e.g., a weather radar), an engine, an auxiliary power unit (APU), an enhanced ground proximity warning system (EGPWS), a satellite navigation system, cabin lighting, a video system, a battery component, an obstacle detection component, a hydraulic component, an electrical component, a control surface (e.g., a rudder, an aileron, a primary control surface, an elevator, flaps, spoilers, slats, and/or the like), a communication component, an image capture device, a situation awareness component (e.g., a traffic alert and collision avoidance system (TCAS), a terrain avoidance and warning system (TAWS), and/or the like), an aircraft satellite communications terminal, a multi-mode digital radio, a cockpit speaker, a crew alerting system (CAS), a flight crew alerting system (FCAS), an aircraft communications addressing and reporting system (ACARS), a line replaceable unit (LRU), a quick access recorder (QAR), an air traffic services unit (ATSU), a communication management unit (CMU), a memory card, a flight data recorder (FDR), a cockpit voice recorder (CVR), an autopilot system, an autothrottle system, a navigation display, an electronic centralized aircraft monitor (ECAM), an engine indicating and crew alerting system (EICAS), a global positioning system (GPS) receiver, a very high frequency (VHF) radio, a high frequency (HF) radio, a transponder, an automatic dependent surveillance-broadcast (ADS-B) system, a fuel quantity indication system, a landing gear system, a brake control system, an environmental control system (ECS), a pressurization system, an oxygen system, a fire detection and suppression system, an ice protection system, a stall warning system, a flight control computer (FCC), an air data computer (ADC), a radio altimeter, an electric propulsion unit, a battery management system (BMS), an electric motor controller, a distributed electric propulsion (DEP) system, a vertical takeoff and landing (VTOL) control system, a tilt rotor mechanism, a vertiport communication system, a detect and avoid (DAA) system, a remote pilot interface module, a geofencing module, an urban airspace management interface, a passenger information display system, a noise monitoring system, an electric power distribution unit, a regenerative braking system, a rotor pitch control system, a fly-by-wire flight control system, a lidar-based obstacle detection system, a vehicle-to-vehicle (V2V) communication system, a vehicle-to-infrastructure (V2I) communication system, an autonomous navigation controller, a waypoint management system, a cargo delivery management system, a MAVLink-compatible bus interface, a DroneCAN bus interface, a UAVCAN bus interface, a return-to-home module, and/or the like. In some embodiments, the one or more backup aircraft components 306 are operated by an aircraft manufacturer, an avionics provider, an airline, a maintenance provider, and/or other entity associated with aircraft operations. In some embodiments, the one or more backup aircraft components 306 may be located within the aircraft 110 and/or on an exterior surface of the aircraft 110. For example, the one or more backup aircraft components 306 may be located in a cockpit, a fuselage, a wing, an empennage, an engine nacelle, and/or a landing gear bay of the aircraft 110. In some embodiments, the one or more backup aircraft components 306 generate data associated with operations of the aircraft 110 and/or receive commands from other aircraft systems. In this regard, for example, the individual backup aircraft components 306 of the aircraft 110 may comprise components associated with a particular process and/or operation performed by the aircraft 110. In some embodiments, the one or more backup aircraft components 306 are physically secured to the aircraft 110. In some embodiments, one or more of the one or more backup aircraft components 306 corresponds to one or more of the aircraft components 304. Said differently, for example, one or more of the one or more backup aircraft components 306 may be a backup for a corresponding aircraft component of the aircraft components 304 such that, if an aircraft component is compromised, the corresponding backup aircraft component may be able to perform the functionality of the compromised aircraft component.

In some embodiments, the one or more backup aircraft components 306 are configured via hardware, software, firmware, and/or a combination thereof, to perform data intake of one or more types of data. Additionally, or alternatively, in some embodiments, the one or more backup aircraft components 306 is configured via hardware, software, firmware, and/or a combination thereof, to generate and/or transmit command(s) that control, adjust, or otherwise impact operations of one or more of the aircraft 110, the cloud-based aircraft cyber threat operations device 140, one or more user devices 190, one or more aircraft components 304, an aircraft bus 302, and/or the onboard aircraft cyber threat operations device 120. For example, the one or more backup aircraft components 306 may be configured to perform one or more cyber threat responsive actions. Additionally, or alternatively, in some embodiments, the one or more backup aircraft components 306 are configured via hardware, software, firmware, and/or a combination thereof, to perform data reporting, provide data, and/or other data output process(es) associated with monitoring or otherwise analyzing operations of one or more of the aircraft 110, the cloud-based aircraft cyber threat operations device 140, one or more aircraft components 304, an aircraft bus 302, one or more user devices 190, and/or the onboard aircraft cyber threat operations device 120. For example, in various embodiments, the one or more backup aircraft components 306 may be configured to execute and/or perform one or more operations and/or functions described herein. In some embodiments, the one or more of the one or more backup aircraft components 306 is a backup line replaceable unit. For example, a first backup aircraft component of the one or more backup aircraft components 306 is a first backup line replaceable unit.

The one or more databases 170 may be configured to receive, store, and/or transmit data. For example, the one or more databases 170 may be configured to receive, store, and/or transmit data associated with the aircraft 110, the cloud-based aircraft cyber threat operations device 140, the onboard aircraft cyber threat operations device 120, one or more user devices 190, one or more backup aircraft components 306, an aircraft bus 302, and/or the one or more aircraft components 304. The one or more databases 170 may be located remotely from the aircraft 110, in proximity of the aircraft 110, and/or within the aircraft 110.

The network 130 may be embodied in any of a myriad of network configurations. In some embodiments, the network 130 may be a public network (e.g., the Internet). In some embodiments, the network 130 may be a private network (e.g., an internal localized, or closed-off network between particular devices). In some other embodiments, the network 130 may be a hybrid network (e.g., a network enabling internal communications between particular connected devices and external communications with other devices). In various embodiments, the network 130 may include one or more base station(s), relay(s), router(s), switch(es), cell tower(s), communications cable(s), routing station(s), and/or the like. In various embodiments, components of the environment 100 may be communicatively coupled to transmit data to and/or receive data from one another over the network 130. Such configuration(s) include, without limitation, a wired or wireless Personal Area Network (PAN), Local Area Network (LAN), Metropolitan Area Network (MAN), Wide Area Network (WAN), and/or the like.

Additionally, while FIG. 1 illustrates certain components as separate, standalone entities communicating over the network 130, various embodiments are not limited to this configuration. In other embodiments, one or more components may be directly connected and/or share hardware or the like. For example, in some embodiments, the cloud-based aircraft cyber threat operations device 140 may include the one or more databases 170.

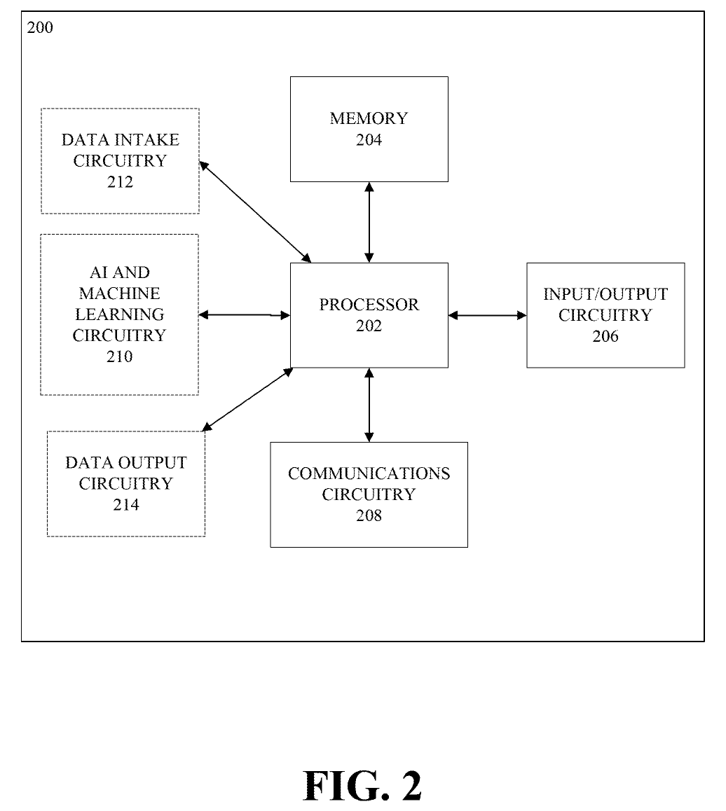

FIG. 2 illustrates an example block diagram of an example apparatus that may be specially configured in accordance with an example embodiment of the present disclosure. Specifically, FIG. 2 depicts an example computing apparatus 200 (“apparatus 200”) specially configured in accordance with at least some example embodiments of the present disclosure. For example, the computing apparatus 200 may be embodied as one or more of a specifically configured personal computing apparatus, a specifically configured cloud-based computing apparatus, a specifically configured embedded computing device (e.g., configured for edge computing, and/or the like). Examples of an apparatus 200 may include, but is not limited to, the cloud-based aircraft cyber threat operations device 140, the onboard aircraft cyber threat operations device 120, the one or more aircraft components 304, the one or more databases 170, the one or more user devices 190, one or more backup aircraft components 306, an aircraft bus 302, and/or the aircraft 110. The apparatus 200 includes processor 202, memory 204, input/output circuitry 206, communications circuitry 208, and/or optional artificial intelligence (“AI”) and machine learning circuitry 210. In some embodiments, the apparatus 200 is configured to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory(ies), circuitry(ies), and/or the like to perform their associated functions such that duplicate hardware is not required for each set of circuitry.

In various embodiments, such as computing apparatus 200 of the cloud-based aircraft cyber threat operations device 140, the onboard aircraft cyber threat operations device 120, the one or more user devices 190, one or more backup aircraft components 306, an aircraft bus 302, and/or the one or more aircraft components 304 may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein. In this regard, the apparatus 200 embodies a particular, specially configured computing entity transformed to enable the specific operations described herein and provide the specific advantages associated therewith, as described herein.

Processor 202 or processor circuitry 202 may be embodied in a number of different ways. In various embodiments, the use of the terms “processor” should be understood to include a single core processor, a multi-core processor, multiple processors internal to the apparatus 200, and/or one or more remote or “cloud” processor(s) external to the apparatus 200. In some example embodiments, processor 202 may include one or more processing devices configured to perform independently. Alternatively, or additionally, processor 202 may include one or more processor(s) configured in tandem via a bus to enable independent execution of operations, instructions, pipelining, and/or multithreading.

In an example embodiment, the processor 202 may be configured to execute instructions stored in the memory 204 or otherwise accessible to the processor. Alternatively, or additionally, the processor 202 may be configured to execute hard-coded functionality. As such, whether configured by hardware or software methods, or by a combination thereof, processor 202 may represent an entity (e.g., physically embodied in circuitry) capable of performing operations according to embodiments of the present disclosure while configured accordingly. Alternatively, or additionally, processor 202 may be embodied as an executor of software instructions, and the instructions may specifically configure the processor 202 to perform the various algorithms embodied in one or more operations described herein when such instructions are executed. In some embodiments, the processor 202 includes hardware, software, firmware, and/or a combination thereof that performs one or more operations described herein.

In some embodiments, the processor 202 (and/or co-processor or any other processing circuitry assisting or otherwise associated with the processor) is/are in communication with the memory 204 via a bus for passing information among components of the apparatus 200.

Memory 204 or memory circuitry 204 may be non-transitory and may include, for example, one or more volatile and/or non-volatile memories. In some embodiments, the memory 204 includes or embodies an electronic storage device (e.g., a computer readable storage medium). In some embodiments, the memory 204 is configured to store information, data, content, applications, instructions, or the like, for enabling an apparatus 200 to carry out various operations and/or functions in accordance with example embodiments of the present disclosure.

Input/output circuitry 206 may be included in the apparatus 200. In some embodiments, input/output circuitry 206 may provide output to the user and/or receive input from a user. The input/output circuitry 206 may be in communication with the processor 202 to provide such functionality. The input/output circuitry 206 may comprise one or more user interface(s). In some embodiments, a user interface may include a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys, a microphone, a speaker, or other input/output mechanisms. The processor 202 and/or input/output circuitry 206 comprising the processor may be configured to control one or more operations and/or functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a computing device and/or other display associated with a user.

Communications circuitry 208 may be included in the apparatus 200. The communications circuitry 208 may include any means such as a device or circuitry embodied in either hardware or a combination of hardware and software that is configured to receive and/or transmit data from/to a network and/or any other device, circuitry, or module in communication with the apparatus 200. In some embodiments the communications circuitry 208 includes, for example, a network interface for enabling communications with a wired or wireless communications network. Additionally, or alternatively, the communications circuitry 208 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 208 may include circuitry for interacting with an antenna(s) and/or other hardware or software to cause transmission of signals via the antenna(s) and/or to handle receipt of signals received via the antenna(s). In some embodiments, the communications circuitry 208 enables transmission to and/or receipt of data from a user device, one or more sensors, and/or other external computing device(s) in communication with the apparatus 200.

Data intake circuitry 212 may be included in the apparatus 200. The data intake circuitry 212 may include hardware, software, firmware, and/or a combination thereof, designed and/or configured to capture, receive, request, and/or otherwise gather data associated with operations of the aircraft 110. In some embodiments, the data intake circuitry 212 includes hardware, software, firmware, and/or a combination thereof, that communicates with one or more sensor(s) component(s), and/or the like within the aircraft 110 to receive particular data associated with such operations of the aircraft 110. Additionally, or alternatively, in some embodiments, the data intake circuitry 212 includes hardware, software, firmware, and/or a combination thereof, that retrieves particular data associated with the aircraft 110 from one or more data repository/repositories accessible to the apparatus 200.

AI and machine learning circuitry 210 may be included in the apparatus 200. The AI and machine learning circuitry 210 may include hardware, software, firmware, and/or a combination thereof designed and/or configured to request, receive, process, generate, and transmit data, data structures, control signals, and electronic information for training and executing a trained AI and machine learning model configured for facilitating the operations and/or functionalities described herein. For example, in some embodiments the AI and machine learning circuitry 210 includes hardware, software, firmware, and/or a combination thereof, that identifies training data and/or utilizes such training data for training a particular machine learning model, AI, and/or other model to generate particular output data based at least in part on learnings from the training data. Additionally, or alternatively, in some embodiments, the AI and machine learning circuitry 210 includes hardware, software, firmware, and/or a combination thereof, that embodies or retrieves a trained machine learning model, AI and/or other specially configured model utilized to process inputted data. Additionally, or alternatively, in some embodiments, the AI and machine learning circuitry 210 includes hardware, software, firmware, and/or a combination thereof that processes received data utilizing one or more algorithm(s), function(s), subroutine(s), and/or the like, in one or more pre-processing and/or subsequent operations that need not utilize a machine learning or AI model.

Data output circuitry 214 may be included in the apparatus 200. The data output circuitry 214 may include hardware, software, firmware, and/or a combination thereof, that configures and/or generates an output based at least in part on data processed by the apparatus 200. In some embodiments, the data output circuitry 214 includes hardware, software, firmware, and/or a combination thereof, that generates a particular report based at least in part on the processed data, for example where the report is generated based at least in part on a particular reporting protocol. Additionally, or alternatively, in some embodiments, the data output circuitry 214 includes hardware, software, firmware, and/or a combination thereof, that configures a particular output data object, output data file, and/or user interface for storing, transmitting, and/or displaying. For example, in some embodiments, the data output circuitry 214 generates and/or specially configures a particular data output for transmission to another system sub-system for further processing. Additionally, or alternatively, in some embodiments, the data output circuitry 214 includes hardware, software, firmware, and/or a combination thereof, that causes rendering of a specially configured user interface based at least in part on data received by and/or processing by the apparatus 200.

In some embodiments, two or more of the sets of circuitries 202-214 are combinable. Alternatively, or additionally, one or more of the sets of circuitry 202-214 perform some or all of the operations and/or functionality described herein as being associated with another circuitry. In some embodiments, two or more of the sets of circuitry 202-214 are combined into a single module embodied in hardware, software, firmware, and/or a combination thereof. For example, in some embodiments, one or more of the sets of circuitry, for example the AI and machine learning circuitry 210, may be combined with the processor 202, such that the processor 202 performs one or more of the operations described herein with respect to the AI and machine learning circuitry 210.

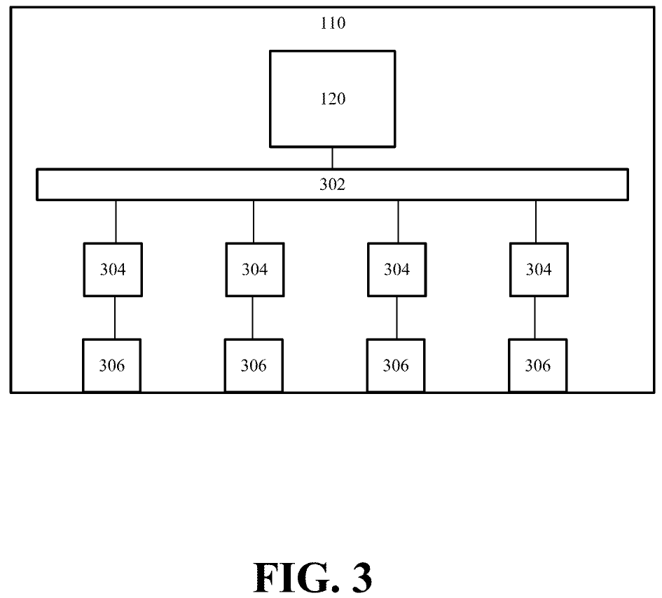

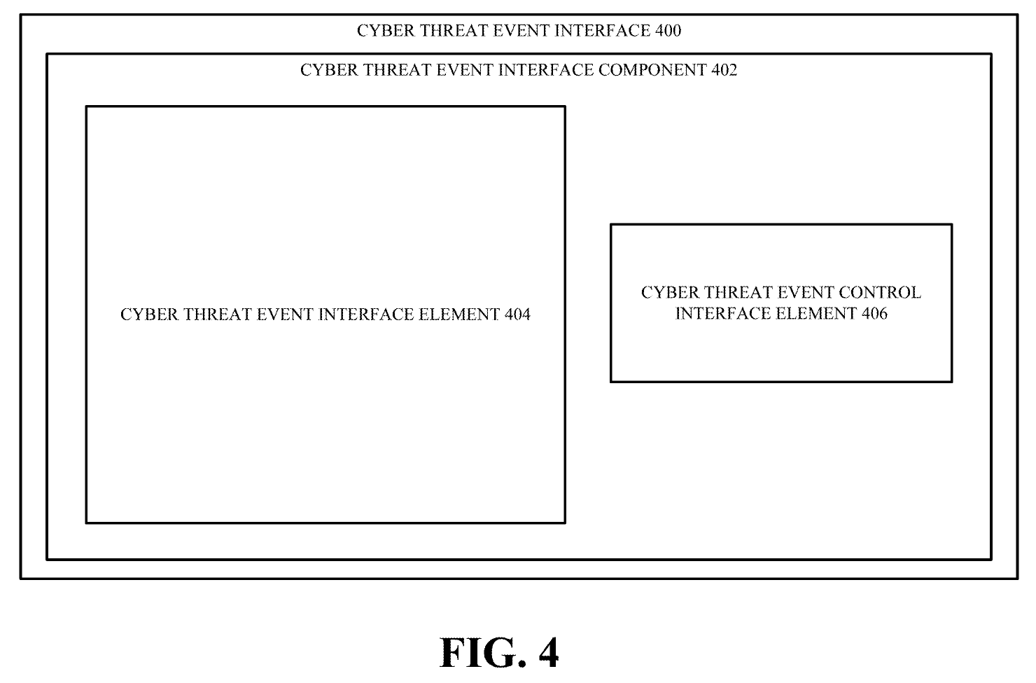

With reference to FIGS. 1-4, in some embodiments, the onboard aircraft cyber threat operations device 120 is configured to receive an aircraft cyber threat detection model from the cloud-based aircraft cyber threat operations device 140. In some embodiments, the onboard aircraft cyber threat operations device 120 may be configured to receive the aircraft cyber threat detection model from the cloud-based aircraft cyber threat operations device 140 in response to a request from the onboard aircraft cyber threat operations device 120. In some embodiments, the onboard aircraft cyber threat operations device 120 is configured to receive an aircraft cyber threat detection model from the cloud-based aircraft cyber threat operations device 140 prior to the aircraft 110 starting an aircraft mission. In some embodiments, the onboard aircraft cyber threat operations device 120 is configured to receive an aircraft cyber threat detection model from the cloud-based aircraft cyber threat operations device 140 prior to the aircraft 110 performing an aircraft mission and/or at the start of an aircraft mission (e.g., during pre-flight procedures). In some embodiments, the onboard aircraft cyber threat operations device 120 is configured to receive the aircraft cyber threat detection model via the network 130, via a wireless communication link, and/or via a wired connection during ground operations. For example, the cloud-based aircraft cyber threat operations device 140 may push the aircraft cyber threat detection model to the onboard aircraft cyber threat operations device 120, and/or the onboard aircraft cyber threat operations device 120 may pull and/or request the aircraft cyber threat detection model from the cloud-based aircraft cyber threat operations device 140. Additionally, or alternatively, in some embodiments, the onboard aircraft cyber threat operations device 120 and/or the cloud-based aircraft cyber threat operations device 140 are configured to perform automatic synchronization of the aircraft cyber threat detection model. In some embodiments, the aircraft cyber threat detection model is received as a software update, as a model file, and/or as a set of parameters and/or weights. In some embodiments, the onboard aircraft cyber threat operations device 120 is configured to verify an integrity of the received aircraft cyber threat detection model and/or authenticate a source of the aircraft cyber threat detection model.

In some embodiments, the onboard aircraft cyber threat operations device 120 is configured to identify an aircraft operational feature. In some embodiments, the onboard aircraft cyber threat operations device 120 is configured to identify an aircraft operational feature from the one or more aircraft components 304 of the aircraft 110 and/or one or more backup aircraft components 306 of the aircraft 110. For example, the onboard aircraft cyber threat operations device 120 is configured to identify an aircraft operational feature from a flight management system (FMS), an enhanced ground proximity warning system (EGPWS), a weather radar, and/or an auxiliary power unit (APU) of the one or more aircraft components 304. Said differently, for example, the onboard aircraft cyber threat operations device 120 may be configured to identify an aircraft operational feature from the one or more line replaceable units and/or one or more backup line replaceable units of the aircraft 110.

In some embodiments, an aircraft operational feature comprises one or more of a sensor reading, telemetry data, a system status indicator, a communication log, navigation data, an engine parameter, a flight control input, an altitude measurement, an airspeed measurement, a heading measurement, a fuel level indicator, a temperature reading, a pressure reading, a vibration measurement, a position coordinate, a rate of climb indicator, a throttle position, a control surface position, a warning indicator, an error code, a system health metric, and/or the like. For example, an aircraft operational feature may comprise data from a flight management system (FMS) indicating a current flight plan, waypoint information, and/or fuel consumption calculations. Additionally, or alternatively, an aircraft operational feature may comprise data from an inertial reference system (IRS) indicating aircraft attitude, velocity, and/or position.

In some embodiments, an aircraft operational feature is formatted and/or structured as time-stamped data, a real-time data stream, a periodic snapshot, event-triggered data, a data packet on the aircraft bus 302, a log entry, a status message, and/or the like. For example, an aircraft operational feature may comprise a continuous stream of sensor data transmitted at a defined sampling rate. Additionally, or alternatively, an aircraft operational feature may comprise an event-triggered data packet generated in response to a change in a system state and/or an anomaly detection. In some embodiments, an aircraft operational feature is transmitted via the aircraft bus 302 and/or stored in a memory associated with an aircraft component of the one or more aircraft components 304 and/or a backup aircraft component of the one or more backup aircraft components 306. In some embodiments, an aircraft operational feature comprises one or more items of data representative and/or indicative of operations of one or more aircraft components 304 and/or one or more backup aircraft components 306 of the aircraft 110 while the aircraft is performing an aircraft mission. For example, an aircraft operational feature may comprise operations of a first aircraft component of the one or more aircraft components 304.

In some embodiments, the onboard aircraft cyber threat operations device 120 is configured to identify an aircraft operational feature by accessing data from the aircraft bus 302. For example, the onboard aircraft cyber threat operations device 120 may monitor data packets transmitted on the aircraft bus 302 and extract aircraft operational features from the monitored data packets. Additionally, or alternatively, in some embodiments, the onboard aircraft cyber threat operations device 120 is configured to identify an aircraft operational feature by receiving data directly from one or more aircraft components 304 and/or one or more backup aircraft components 306. In some embodiments, the onboard aircraft cyber threat operations device 120 is configured to identify an aircraft operational feature by querying one or more aircraft components 304 and/or one or more backup aircraft components 306 for particular data. Additionally, or alternatively, in some embodiments, the onboard aircraft cyber threat operations device 120 is configured to identify an aircraft operational feature by generating derived data based on raw data received from one or more aircraft components 304. For example, the onboard aircraft cyber threat operations device 120 may generate a derived aircraft operational feature by calculating a rate of change of a sensor reading over time and/or by aggregating multiple sensor readings into a composite metric.

In some embodiments, the onboard aircraft cyber threat operations device 120 is configured to identify an aircraft operational feature during an aircraft mission performed by the aircraft 110. For example, the onboard aircraft cyber threat operations device 120 may be configured to identify an aircraft operational feature during a preflight procedure phase, a taxi phase, a takeoff phase, a climb phase, a cruise phase, a descent phase, a landing phase, and/or a post flight procedure phase of the aircraft mission. In some embodiments, the onboard aircraft cyber threat operations device 120 is configured to continuously identify aircraft operational features throughout the aircraft mission. Additionally, or alternatively, in some embodiments, the onboard aircraft cyber threat operations device 120 is configured to identify aircraft operational features at periodic intervals during the aircraft mission. In some embodiments, the onboard aircraft cyber threat operations device 120 is configured to identify aircraft operational features in response to a triggering event, such as a change in a system state, a transition between phases of the aircraft mission, and/or a detection of an anomaly. In some embodiments, the onboard aircraft cyber threat operations device 120 is configured to identify aircraft operational features prior to the aircraft mission, for example during ground operations and/or while the aircraft 110 is parked at a gate.

In some embodiments, the onboard aircraft cyber threat operations device 120 is configured to detect an aircraft cyber threat event. In some embodiments, an aircraft cyber threat event is an event that may impact a cybersecurity of the aircraft 110, one or more of the one or more aircraft components 304, one or more of the one or more backup aircraft components 306, and/or the like. In this regard, in some embodiments, an aircraft cyber threat event comprises access of a first aircraft component of the one or more aircraft components 304 by a computing agent. In some embodiments, a computing agent is not authorized to access a first aircraft component. For example, an aircraft cyber threat event may comprise a computing agent attempting to alter one or more aircraft operational features associated with the aircraft 110. As another example, an aircraft cyber threat event may comprise a computing agent attempting to control one or more functionalities of the aircraft 110. Additionally, or alternatively, in some embodiments, an aircraft cyber threat event may comprise unauthorized data exfiltration from an aircraft component, injection of malicious commands onto the aircraft bus 302, spoofing of sensor data and/or navigation information, denial of service attacks targeting aircraft systems, unauthorized modification of flight parameters, tampering with communication links, and/or exploitation of software vulnerabilities in an aircraft component. In some embodiments, an aircraft cyber threat event may comprise an attempt to compromise a flight management system (FMS), an autopilot system, a navigation system, a communication system, and/or a flight control computer.

In some embodiments, the onboard aircraft cyber threat operations device 120 is configured to detect an aircraft cyber threat event by applying an aircraft operational feature to the aircraft cyber threat detection model. For example, the onboard aircraft cyber threat operations device 120 may apply one or more aircraft operational features from one or more aircraft components 304 and/or one or more backup aircraft components 306 to the aircraft cyber threat detection model to determine whether an aircraft cyber threat event has occurred and/or is occurring. In some embodiments, the aircraft cyber threat detection model may analyze patterns in communication traffic on the aircraft bus 302 to detect anomalous data packets, unauthorized command sequences, and/or unexpected data transmission frequencies that deviate from established baseline operational patterns. For example, the aircraft cyber threat detection model may detect an aircraft cyber threat event when an aircraft operational feature indicates that a flight management system (FMS) is receiving navigation commands from an unauthorized source and/or at an unexpected frequency. As another example, the aircraft cyber threat detection model may detect an aircraft cyber threat event when sensor readings from an inertial reference system (IRS) exhibit sudden deviations that are inconsistent with corresponding readings from other aircraft components 304, indicating potential sensor spoofing and/or data injection. Additionally, or alternatively, the aircraft cyber threat detection model may detect an aircraft cyber threat event by identifying unauthorized access attempts based on authentication failures, unexpected login patterns, and/or access requests originating from unrecognized computing agents. In some embodiments, the aircraft cyber threat detection model may correlate multiple aircraft operational features across different aircraft components 304 to detect coordinated attack patterns, such as simultaneous anomalies in communication logs, system status indicators, and/or control surface positions that individually may appear benign but collectively indicate a cyber threat event. For example, the aircraft cyber threat detection model may detect an aircraft cyber threat event when an aircraft operational feature indicates an unexpected modification to flight parameters in the autopilot system that was not initiated by an authorized operator input. In some embodiments, the onboard aircraft cyber threat operations device 120 is configured to generate one or more logs that comprise an aircraft cyber threat event. Additionally, or alternatively, in some embodiments, the onboard aircraft cyber threat operations device 120 is configured to generate an alert, a notification, and/or a warning in response to detecting an aircraft cyber threat event.

In some embodiments, the aircraft cyber threat detection model comprises software and/or hardware that comprises parameters, hyper-parameters, and/or defined operations of a rules-based, machine learning model, and/or generative artificial intelligence model configured to detect an aircraft cyber threat event. For example, an aircraft cyber threat detection model may comprise at least one of one or more rule-based layers, one or more layers that depend on trained parameters, coefficients, and/or the like. In this regard, in some embodiments, the aircraft cyber threat detection model may be configured to utilize one or more of any type of machine learning, rules-based, and/or artificial intelligence techniques. For example, the aircraft cyber threat detection model may utilize one or more of computer vision techniques, supervised learning (e.g., using user feedback), unsupervised learning, semi-supervised learning, reinforcement learning, sequence modeling techniques, variational autoencoder techniques, generative adversarial network techniques, natural language processing techniques, neural network techniques, and/or generative artificial intelligence techniques.

In some embodiments, an aircraft cyber threat event is detected during a cruise phase of an aircraft mission performed by the aircraft 110. Additionally, or alternatively, in some embodiments, an aircraft cyber threat event is detected during a preflight procedure phase, a taxi phase, a takeoff phase, a climb phase, a descent phase, a landing phase, and/or a post flight procedure phase of an aircraft mission. In some embodiments, the onboard aircraft cyber threat operations device 120 is configured to continuously monitor for aircraft cyber threat events throughout an aircraft mission. Additionally, or alternatively, in some embodiments, the onboard aircraft cyber threat operations device 120 is configured to monitor for aircraft cyber threat events at periodic intervals and/or in response to a triggering event.

In some embodiments, the cloud-based aircraft cyber threat operations device 140 is configured to receive an aviation operational feature. In some embodiments, the aviation operational feature comprises one or more items of data representative and/or indicative of operations of one or more other aircraft (e.g., aircraft other than the aircraft 110, such as a second aircraft). For example, an aviation operational feature may be representative of operations, such as historical operations, of one or more other aircraft components associated with other aircraft. Additionally, or alternatively, an aviation operational feature comprises one or more items of data representative and/or indicative of other aircraft cyber threat events associated with one or more other aircraft. In this regard, in some embodiments, an aviation operational feature may comprise historical data.

In some embodiments, an aviation operational feature comprises aggregated sensor data from a plurality of aircraft, fleet-wide telemetry data, maintenance records, flight logs, anomaly reports, cyber incident reports from other aircraft, and/or communication patterns across a fleet. For example, an aviation operational feature may comprise data indicative of a cyber threat event that occurred on a second aircraft and/or data indicative of a pattern of cyber threat events across a plurality of aircraft. Additionally, or alternatively, an aviation operational feature may comprise historical flight data, historical maintenance data, historical system performance data, and/or historical cyber threat detection data from one or more other aircraft.

In some embodiments, an aviation operational feature is received from an airline operations center, a maintenance provider, a regulatory agency, and/or one or more other cloud-based systems. For example, an aviation operational feature may be received as a real-time data stream, a batch data upload, and/or an anonymized data set from a plurality of airlines. Additionally, or alternatively, an aviation operational feature may comprise data formatted as a structured data file, a database record, an application programming interface (API) response, and/or a standardized aviation data format. In some embodiments, an aviation operational feature is aggregated and/or anonymized prior to being received by the cloud-based aircraft cyber threat operations device 140.

In some embodiments, the cloud-based aircraft cyber threat operations device 140 is configured to train the aircraft cyber threat detection model. For example, the cloud-based aircraft cyber threat operations device 140 may be configured to train the aircraft cyber threat detection model using an aviation operational feature. In some embodiments, training the aircraft cyber threat detection model comprises adjusting one or more weights, parameters, and/or coefficients of the aircraft cyber threat detection model based on a training data set. For example, training the aircraft cyber threat detection model may comprise applying a loss function and/or an optimization algorithm to minimize an error between a predicted output and/or an expected output. Additionally, or alternatively, in some embodiments, training the aircraft cyber threat detection model comprises performing one or more training iterations and/or epochs over a training data set. In some embodiments, training the aircraft cyber threat detection model comprises utilizing a training data set, a validation data set, and/or a test data set to evaluate and/or improve a performance of the aircraft cyber threat detection model. For example, the cloud-based aircraft cyber threat operations device 140 may be configured to update the aircraft cyber threat detection model based on feedback and/or error metrics generated during training. Additionally, or alternatively, in some embodiments, the cloud-based aircraft cyber threat operations device 140 is configured to fine-tune and/or retrain the aircraft cyber threat detection model based on new aviation operational features and/or updated cyber threat information.

In some embodiments, the cloud-based aircraft cyber threat operations device 140 is configured to deploy the aircraft cyber threat detection model to the onboard aircraft cyber threat operations device 120. For example, the cloud-based aircraft cyber threat operations device 140 may be configured to deploy the aircraft cyber threat detection model to the onboard aircraft cyber threat operations device 120 via the network 130, via a wireless communication link, and/or via a wired connection during ground operations. In some embodiments, the cloud-based aircraft cyber threat operations device 140 may push the aircraft cyber threat detection model to the onboard aircraft cyber threat operations device 120. Additionally, or alternatively, in some embodiments, the onboard aircraft cyber threat operations device 120 may pull and/or request the aircraft cyber threat detection model from the cloud-based aircraft cyber threat operations device 140. In some embodiments, the aircraft cyber threat detection model is deployed as a software update, as a model file, and/or as a set of parameters and/or weights. Additionally, or alternatively, in some embodiments, the cloud-based aircraft cyber threat operations device 140 and/or the onboard aircraft cyber threat operations device 120 are configured to perform automatic deployment and/or synchronization of the aircraft cyber threat detection model. In some embodiments, the onboard aircraft cyber threat operations device 120 is configured to verify an integrity of the deployed aircraft cyber threat detection model and/or validate a performance of the deployed aircraft cyber threat detection model.

In some embodiments, the cloud-based aircraft cyber threat operations device 140 is configured to deploy the aircraft cyber threat detection model to the onboard aircraft cyber threat operations device 120 after the cloud-based aircraft cyber threat operations device 140 has trained the aircraft cyber threat detection model. Additionally, or alternatively, in some embodiments, the cloud-based aircraft cyber threat operations device 140 is configured to deploy the aircraft cyber threat detection model prior to an aircraft mission performed by the aircraft 110. For example, the cloud-based aircraft cyber threat operations device 140 may deploy the aircraft cyber threat detection model during ground operations, during a preflight procedure phase, and/or while the aircraft 110 is parked at a gate. In some embodiments, the cloud-based aircraft cyber threat operations device 140 is configured to deploy the aircraft cyber threat detection model at periodic intervals. Additionally, or alternatively, in some embodiments, the cloud-based aircraft cyber threat operations device 140 is configured to deploy the aircraft cyber threat detection model in response to updated cyber threat information and/or when a new model version is available.

In some embodiments, the onboard aircraft cyber threat operations device 120 is configured to perform one or more aircraft cyber threat responsive actions. In some embodiments, the onboard aircraft cyber threat operations device 120 is configured to perform one or more aircraft cyber threat responsive actions based on the aircraft cyber threat event. In some embodiments, the onboard aircraft cyber threat operations device 120 is configured to perform one or more aircraft cyber threat responsive actions in response to detecting the aircraft cyber threat event. For example, the onboard aircraft cyber threat operations device 120 may perform one or more aircraft cyber threat responsive actions immediately upon detection of the aircraft cyber threat event. Additionally, or alternatively, in some embodiments, the onboard aircraft cyber threat operations device 120 is configured to perform one or more aircraft cyber threat responsive actions when a threat severity level associated with the aircraft cyber threat event exceeds a predefined threshold. In some embodiments, the onboard aircraft cyber threat operations device 120 is configured to perform one or more aircraft cyber threat responsive actions during an aircraft mission, such as during a preflight procedure phase, a taxi phase, a takeoff phase, a climb phase, a cruise phase, a descent phase, a landing phase, and/or a post flight procedure phase. In some embodiments, the onboard aircraft cyber threat operations device 120 is configured to perform one or more aircraft cyber threat responsive actions in real-time while the aircraft 110 is in flight. Additionally, or alternatively, in some embodiments, the onboard aircraft cyber threat operations device 120 is configured to perform one or more aircraft cyber threat responsive actions when the aircraft cyber threat event is associated with a particular aircraft component of the one or more aircraft components 304. In some embodiments, the onboard aircraft cyber threat operations device 120 is configured to perform one or more aircraft cyber threat responsive actions when the aircraft cyber threat event indicates unauthorized access, data exfiltration, command injection, sensor spoofing, and/or denial of service targeting one or more aircraft components 304. In some embodiments, the onboard aircraft cyber threat operations device 120 is configured to perform one or more aircraft cyber threat responsive actions autonomously without requiring operator input. Additionally, or alternatively, in some embodiments, the onboard aircraft cyber threat operations device 120 is configured to perform one or more aircraft cyber threat responsive actions after receiving confirmation from an operator of the aircraft 110.

In some embodiments, the performing one or more aircraft cyber threat responsive actions comprises causing a first aircraft component (e.g. an aircraft component associated with a cyber threat event) to enter a safe operational mode (e.g., when the cyber threat event is above a particular threat threshold). In some embodiments, a safe operational mode comprises a restricted operational state, a limited functionality mode, and/or a reduced capability mode. In some embodiments, in a safe operational mode an aircraft component will only provide, facilitate, and/or the like operations that enable the aircraft to aviate, navigate, and communicate (ANAC). For example, in a safe operational mode operations such as autopilot disengagement, navigation alteration request, specific communication functions, and/or the like may be disabled. Additionally, or alternatively, in some embodiments, in a safe operational mode an aircraft component may disable non-essential data processing, restrict external communication interfaces, limit access to configuration parameters, and/or prevent execution of commands from untrusted sources. In some embodiments, causing a first aircraft component to enter a safe operational mode comprises sending a command to the first aircraft component. For example, the onboard aircraft cyber threat operations device 120 may transmit a control signal to the first aircraft component instructing the first aircraft component to enter a safe operational mode. Additionally, or alternatively, in some embodiments, causing a first aircraft component to enter a safe operational mode comprises modifying one or more configuration parameters associated with the first aircraft component. In some embodiments, causing a first aircraft component to enter a safe operational mode comprises isolating the first aircraft component from one or more data paths on the aircraft bus 302. For example, the onboard aircraft cyber threat operations device 120 may restrict data flow to and/or from the first aircraft component to prevent a computing agent from accessing and/or controlling the first aircraft component.

In some embodiments, when the first aircraft component is in a safe operational mode, the onboard aircraft cyber threat operations device 120 is configured to receive an override input from an operator of the aircraft 110 (e.g., a pilot). For example, the onboard aircraft cyber threat operations device 120 may receive an override input via a user interface, a physical switch, a voice command, and/or a dedicated override control on a flight deck. In some embodiments, the onboard aircraft cyber threat operations device 120 is configured to determine that the aircraft 110 is associated with an emergency event based on one or more aircraft operational features. In some embodiments, one or more aircraft operational features may be aircraft operations data. For example, the onboard aircraft cyber threat operations device 120 may analyze sensor readings, system status indicators, warning indicators, and/or error codes to determine that an emergency event is occurring. Additionally, or alternatively, in some embodiments, the onboard aircraft cyber threat operations device 120 may determine that an emergency event is occurring based on an altitude measurement, an airspeed measurement, a rate of descent, a proximity to terrain, and/or an engine parameter indicating a malfunction. In some embodiments, the onboard aircraft cyber threat operations device 120 is configured to disable safe operational mode associated with the first aircraft component in response to determining that the aircraft 110 is associated with an emergency event. For example, the onboard aircraft cyber threat operations device 120 may transmit a command to the first aircraft component instructing the first aircraft component to exit safe operational mode and/or restore full functionality. Additionally, or alternatively, in some embodiments, the onboard aircraft cyber threat operations device 120 may modify one or more configuration parameters associated with the first aircraft component to re-enable previously disabled operations and/or data paths.

In some embodiments, the onboard aircraft cyber threat operations device 120 may comprise one or more onboard computing agents for detecting an aircraft cyber threat event and/or performing aircraft cyber threat responsive actions. In some embodiments, an onboard computing agent comprises a software module, a process, an application, and/or an autonomous agent configured to execute on the onboard aircraft cyber threat operations device 120. For example, an onboard computing agent may comprise a monitoring agent configured to monitor data on the aircraft bus 302, a detection agent configured to analyze aircraft operational features and/or execute detection algorithms, a response agent configured to initiate and/or perform aircraft cyber threat responsive actions, and/or a logging agent configured to record aircraft cyber threat events and/or responsive actions. In some embodiments, one or more onboard computing agents are configured to operate autonomously without requiring operator input. Additionally, or alternatively, in some embodiments, one or more onboard computing agents are configured to operate in coordination with each other and/or under supervision of the onboard aircraft cyber threat operations device 120. For example, a monitoring agent may identify an anomalous aircraft operational feature and/or transmit the anomalous aircraft operational feature to a detection agent for further analysis. In some embodiments, a detection agent may apply an aircraft operational feature to the aircraft cyber threat detection model and/or generate an alert in response to detecting an aircraft cyber threat event. Additionally, or alternatively, in some embodiments, a response agent may receive an alert from a detection agent and/or initiate one or more aircraft cyber threat responsive actions based on the alert.

In some embodiments, performing one or more aircraft cyber threat responsive actions comprises determining that a first aircraft operations item is located on the aircraft bus 302. In some embodiments, an aircraft operations item comprises one or more items of data that is generated by an aircraft component associated with a cyber threat event and has been provided to the aircraft bus 302. For example, an aircraft operations item may comprise a navigation command, a sensor reading, a control surface command, a communication message, a flight parameter update, a system status message, and/or the like. Additionally, or alternatively, in some embodiments, an aircraft operations item may comprise data transmitted by a compromised aircraft component to other aircraft components 304 and/or backup aircraft components 306 via the aircraft bus 302. In some embodiments, the onboard aircraft cyber threat operations device 120 is configured to determine that an aircraft operations item is located on the aircraft bus 302 by monitoring data packets transmitted on the aircraft bus 302. For example, the onboard aircraft cyber threat operations device 120 may analyze data headers, compare data against expected data patterns, and/or identify data originating from an aircraft component associated with a cyber threat event.

In some embodiments, performing one or more aircraft cyber threat responsive actions comprises invalidating the aircraft operations item in response to determining that the aircraft operations item is located on the aircraft bus 302. In some embodiments, invalidating the aircraft operations item comprises applying an invalidation indicator to the aircraft operations item (e.g., indicating that the aircraft operations item is associated with an aircraft cyber threat event) and/or removing the aircraft operations item from the aircraft bus 302. For example, invalidating the aircraft operations item may comprise setting a flag associated with the aircraft operations item, modifying a status field of the aircraft operations item, broadcasting an invalidation message to other aircraft components 304, overwriting the aircraft operations item, and/or preventing other aircraft components 304 from reading the aircraft operations item. In some embodiments, after invalidating the aircraft operations item, other aircraft components 304 and/or backup aircraft components 306 are configured to ignore the invalidated aircraft operations item. Additionally, or alternatively, in some embodiments, after invalidating the aircraft operations item, a backup aircraft component of the one or more backup aircraft components 306 may provide backup data to replace the invalidated aircraft operations item.

In some embodiments, performing one or more aircraft cyber threat responsive actions comprises activating a first backup aircraft component corresponding to the first aircraft component. In this regard, in some embodiments, the first backup aircraft component may be configured to perform the functionalities of the first aircraft component when the first aircraft component is in a safe operational mode. For example, a first backup aircraft component may comprise a backup flight management system, a backup navigation system, a backup communication system, a backup autopilot system, a backup flight control computer, and/or the like. In some embodiments, activating a first backup aircraft component comprises sending an activation command to the first backup aircraft component. Additionally, or alternatively, in some embodiments, activating a first backup aircraft component comprises switching one or more data paths on the aircraft bus 302 from the first aircraft component to the first backup aircraft component. For example, the onboard aircraft cyber threat operations device 120 may redirect data flow on the aircraft bus 302 such that other aircraft components 304 receive data from the first backup aircraft component instead of the first aircraft component. In some embodiments, activating a first backup aircraft component comprises transferring operational control from the first aircraft component to the first backup aircraft component. For example, the onboard aircraft cyber threat operations device 120 may facilitate a seamless handover from the first aircraft component to the first backup aircraft component. Additionally, or alternatively, in some embodiments, activating a first backup aircraft component comprises synchronizing data between the first aircraft component and/or the first backup aircraft component to ensure continuity of operations.

In some embodiments, performing one or more aircraft cyber threat responsive actions comprises disabling access to a second aircraft component of the one or more aircraft components by a computing agent (e.g., a computing agent associated with an aircraft cyber threat event). In some embodiments, the second aircraft component comprises a flight management system. Additionally, or alternatively, in some embodiments, the second aircraft component comprises an autopilot system, a navigation display, a communication system, a flight control computer, and/or the like. In some embodiments, disabling access to a second aircraft component comprises revoking one or more authentication credentials associated with the computing agent. Additionally, or alternatively, in some embodiments, disabling access to a second aircraft component comprises blocking one or more network connections and/or communication links associated with the computing agent. For example, the onboard aircraft cyber threat operations device 120 may terminate one or more active sessions between the computing agent and/or the second aircraft component. In some embodiments, disabling access to a second aircraft component comprises modifying one or more access control lists and/or permission settings associated with the second aircraft component. For example, the onboard aircraft cyber threat operations device 120 may update a firewall rule, a security policy, and/or an access control configuration to prevent the computing agent from accessing the second aircraft component. In some embodiments, after disabling access to a second aircraft component, the onboard aircraft cyber threat operations device 120 is configured to generate a log entry and/or an alert indicating that access has been disabled. Additionally, or alternatively, in some embodiments, after disabling access to a second aircraft component, the onboard aircraft cyber threat operations device 120 is configured to transmit a notification to an operator of the aircraft 110.

In some embodiments, performing one or more aircraft cyber threat responsive actions comprises generating an aircraft cyber threat event interface component 402. In some embodiments, the aircraft cyber threat event interface component 402 comprises an aircraft cyber threat event interface element 404. In some embodiments, the aircraft cyber threat event interface element 404 is configured to display one or more items of information indicative of an aircraft cyber threat event. For example, the aircraft cyber threat event interface element 404 may display a threat type, a threat severity level, an affected aircraft component, a timestamp associated with an aircraft cyber threat event, a recommended responsive action, and/or a status of one or more aircraft cyber threat responsive actions. Additionally, or alternatively, in some embodiments, the aircraft cyber threat event interface element 404 may display one or more aircraft operational features associated with an aircraft cyber threat event, one or more logs associated with an aircraft cyber threat event, and/or one or more alerts and/or notifications. In some embodiments, generating the aircraft cyber threat event interface element 404 comprises retrieving data associated with an aircraft cyber threat event from a memory, a log, and/or the aircraft cyber threat detection model. For example, the onboard aircraft cyber threat operations device 120 may compile and/or format data associated with an aircraft cyber threat event into a displayable format for the aircraft cyber threat event interface element 404. Additionally, or alternatively, in some embodiments, generating the aircraft cyber threat event interface element 404 comprises dynamically updating the aircraft cyber threat event interface element 404 based on real-time data associated with an aircraft cyber threat event and/or one or more aircraft cyber threat responsive actions.

In some embodiments, the aircraft cyber threat event interface component 402 comprises an aircraft cyber threat event control interface element 406. In some embodiments, the aircraft cyber threat event control interface element 406 is configured to receive user input from an operator of the aircraft 110. For example, an operator may interact with the aircraft cyber threat event control interface element 406 to acknowledge an alert, initiate an aircraft cyber threat responsive action, override a safe operational mode, and/or request additional information associated with an aircraft cyber threat event. Additionally, or alternatively, in some embodiments, the aircraft cyber threat event control interface element 406 may be used to modify one or more aircraft cyber threat responsive actions, select a particular responsive action from a plurality of recommended responsive actions, and/or confirm execution of an aircraft cyber threat responsive action. In some embodiments, the aircraft cyber threat event control interface element 406 comprises one or more control elements such as a button, a toggle, a slider, a dropdown menu, a text input field, and/or a touch-sensitive area. For example, the aircraft cyber threat event control interface element 406 may comprise a button for activating a backup aircraft component, a toggle for enabling and/or disabling safe operational mode, and/or a dropdown menu for selecting a particular aircraft cyber threat responsive action. In some embodiments, the onboard aircraft cyber threat operations device 120 is configured to receive input from the aircraft cyber threat event control interface element 406 and/or perform one or more aircraft cyber threat responsive actions based on the received input.

In some embodiments, performing one or more aircraft cyber threat responsive actions comprises causing the aircraft cyber threat event interface component 402 to be rendered to an aircraft cyber threat event interface 400. In some embodiments, the aircraft cyber threat event interface 400 may be provided on the onboard aircraft cyber threat operations device 120. Additionally, or alternatively, in some embodiments, the aircraft cyber threat event interface 400 may be provided on a user device 190, a display in a cockpit, a primary flight display, a multi-function control and display unit (MCDU), and/or a dedicated cybersecurity display. In some embodiments, causing the aircraft cyber threat event interface component 402 to be rendered comprises transmitting rendering instructions and/or display data to a display device. For example, the onboard aircraft cyber threat operations device 120 may transmit the aircraft cyber threat event interface component 402 to a display for rendering. In some embodiments, the aircraft cyber threat event interface 400 is configured to receive user input from an operator of the aircraft 110. For example, an operator may interact with the aircraft cyber threat event interface 400 to acknowledge an alert, initiate an aircraft cyber threat responsive action, override a safe operational mode, and/or request additional information associated with an aircraft cyber threat event. Additionally, or alternatively, in some embodiments, the aircraft cyber threat event interface 400 is configured to display one or more control elements for initiating and/or modifying one or more aircraft cyber threat responsive actions.

### Example Methods

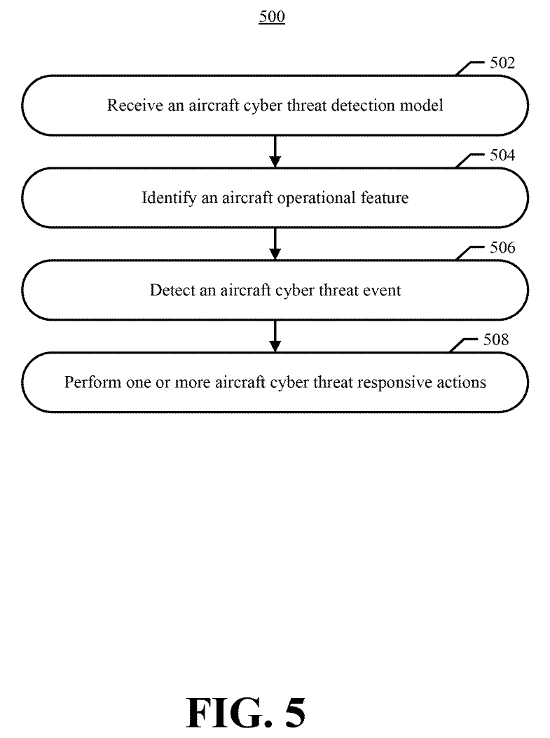

Referring now to FIG. 5, a flowchart providing an example method 500 is illustrated. In this regard, FIG. 5 illustrates operations that may be performed by the aircraft 110, the cloud-based aircraft cyber threat operations device 140, the onboard aircraft cyber threat operations device 120, the one or more user devices 190, the one or more aircraft components 304, the one or more backup aircraft components 306, the aircraft bus 302, and/or the like. In some embodiments, the method 500 comprises operations for detecting and/or responding to aircraft cyber threat events. In some embodiments, the example method 500 defines a computer-implemented process, which may be executable by any of the device(s) and/or system(s) embodied in hardware, software, firmware, and/or a combination thereof, as described herein. In some embodiments, computer program code comprising one or more computer-coded instructions are stored to at least one non-transitory computer-readable storage medium, such that execution of the computer program code initiates performance of the method 500.

As shown in block 502, the method 500 may comprise receiving an aircraft cyber threat detection model. In some embodiments, the onboard aircraft cyber threat operations device 120 is configured to receive an aircraft cyber threat detection model from the cloud-based aircraft cyber threat operations device 140. In some embodiments, the onboard aircraft cyber threat operations device 120 may be configured to receive the aircraft cyber threat detection model from the cloud-based aircraft cyber threat operations device 140 in response to a request from the onboard aircraft cyber threat operations device 120. In some embodiments, the onboard aircraft cyber threat operations device 120 is configured to receive an aircraft cyber threat detection model from the cloud-based aircraft cyber threat operations device 140 prior to the aircraft 110 starting an aircraft mission. For example, the cloud-based aircraft cyber threat operations device 140 may push the aircraft cyber threat detection model to the onboard aircraft cyber threat operations device 120, and/or the onboard aircraft cyber threat operations device 120 may pull and/or request the aircraft cyber threat detection model from the cloud-based aircraft cyber threat operations device 140. Additionally, or alternatively, in some embodiments, the onboard aircraft cyber threat operations device 120 and/or the cloud-based aircraft cyber threat operations device 140 are configured to perform automatic synchronization of the aircraft cyber threat detection model. In some embodiments, the aircraft cyber threat detection model is received as a software update, as a model file, and/or as a set of parameters and/or weights.

As shown in block 504, the method 500 may comprise identifying an aircraft operational feature. In some embodiments, the onboard aircraft cyber threat operations device 120 is configured to identify an aircraft operational feature from the one or more aircraft components 304 of the aircraft 110 and/or one or more backup aircraft components 306 of the aircraft 110. For example, the onboard aircraft cyber threat operations device 120 is configured to identify an aircraft operational feature from a flight management system (FMS), an enhanced ground proximity warning system (EGPWS), a weather radar, and/or an auxiliary power unit (APU) of the one or more aircraft components 304. In some embodiments, an aircraft operational feature comprises one or more of a sensor reading, telemetry data, a system status indicator, a communication log, navigation data, an engine parameter, a flight control input, an altitude measurement, an airspeed measurement, a heading measurement, a fuel level indicator, a temperature reading, a pressure reading, a vibration measurement, a position coordinate, a rate of climb indicator, a throttle position, a control surface position, a warning indicator, an error code, a system health metric, and/or the like. In some embodiments, the onboard aircraft cyber threat operations device 120 is configured to identify an aircraft operational feature by accessing data from the aircraft bus 302. For example, the onboard aircraft cyber threat operations device 120 may monitor data packets transmitted on the aircraft bus 302 and/or extract aircraft operational features from the monitored data packets.

As shown in block 506, the method 500 may comprise detecting an aircraft cyber threat event. In some embodiments, the onboard aircraft cyber threat operations device 120 is configured to detect an aircraft cyber threat event by applying an aircraft operational feature to the aircraft cyber threat detection model. For example, the onboard aircraft cyber threat operations device 120 may apply one or more aircraft operational features from one or more aircraft components 304 and/or one or more backup aircraft components 306 to the aircraft cyber threat detection model to determine whether an aircraft cyber threat event has occurred and/or is occurring. In some embodiments, the aircraft cyber threat detection model may analyze patterns in communication traffic on the aircraft bus 302 to detect anomalous data packets, unauthorized command sequences, and/or unexpected data transmission frequencies that deviate from established baseline operational patterns. For example, the aircraft cyber threat detection model may detect an aircraft cyber threat event when an aircraft operational feature indicates that a flight management system (FMS) is receiving navigation commands from an unauthorized source and/or at an unexpected frequency. Additionally, or alternatively, the aircraft cyber threat detection model may detect an aircraft cyber threat event when sensor readings from an inertial reference system (IRS) exhibit sudden deviations that are inconsistent with corresponding readings from other aircraft components 304, indicating potential sensor spoofing and/or data injection.

As shown in block 508, the method 500 may comprise performing one or more aircraft cyber threat responsive actions. In some embodiments, the onboard aircraft cyber threat operations device 120 is configured to perform one or more aircraft cyber threat responsive actions based on the aircraft cyber threat event. In some embodiments, the onboard aircraft cyber threat operations device 120 is configured to perform one or more aircraft cyber threat responsive actions in response to detecting the aircraft cyber threat event. For example, the onboard aircraft cyber threat operations device 120 may perform one or more aircraft cyber threat responsive actions immediately upon detection of the aircraft cyber threat event. In some embodiments, performing one or more aircraft cyber threat responsive actions comprises causing a first aircraft component to enter a safe operational mode, determining that an aircraft operations item is located on the aircraft bus 302 and/or invalidating the aircraft operations item, activating a first backup aircraft component corresponding to the first aircraft component, disabling access to a second aircraft component by a computing agent, and/or generating an aircraft cyber threat event interface component 402. In some embodiments, the onboard aircraft cyber threat operations device 120 is configured to perform one or more aircraft cyber threat responsive actions autonomously without requiring operator input. Additionally, or alternatively, in some embodiments, the onboard aircraft cyber threat operations device 120 is configured to perform one or more aircraft cyber threat responsive actions after receiving confirmation from an operator of the aircraft 110.

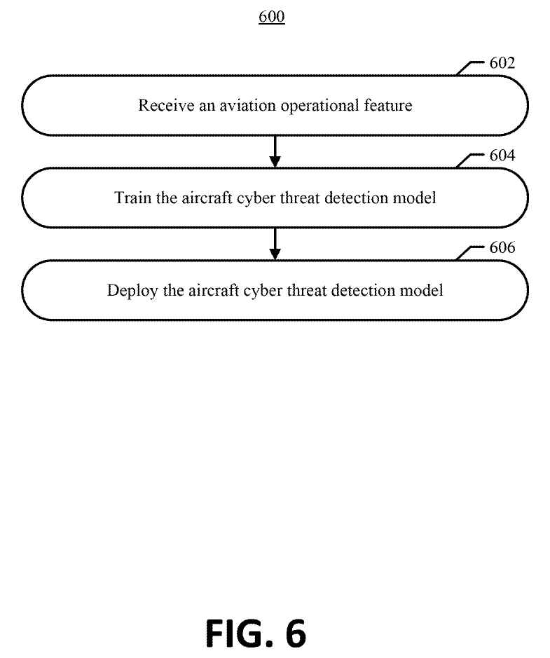

Referring now to FIG. 6, a flowchart providing an example method 600 is illustrated. In this regard, FIG. 6 illustrates operations that may be performed by the aircraft 110, the cloud-based aircraft cyber threat operations device 140, the onboard aircraft cyber threat operations device 120, the one or more user devices 190, the one or more aircraft components 304, the one or more backup aircraft components 306, the aircraft bus 302, and/or the like. In some embodiments, the method 600 comprises operations for training and/or deploying an aircraft cyber threat detection model. In some embodiments, the example method 600 defines a computer-implemented process, which may be executable by any of the device(s) and/or system(s) embodied in hardware, software, firmware, and/or a combination thereof, as described herein. In some embodiments, computer program code comprising one or more computer-coded instructions are stored to at least one non-transitory computer-readable storage medium, such that execution of the computer program code initiates performance of the method 600.

As shown in block 602, the method 600 may comprise receiving an aviation operational feature. In some embodiments, the cloud-based aircraft cyber threat operations device 140 is configured to receive an aviation operational feature. In some embodiments, the aviation operational feature comprises one or more items of data representative and/or indicative of operations of one or more other aircraft (e.g., aircraft other than the aircraft 110, such as a second aircraft). For example, an aviation operational feature may be representative of operations, such as historical operations, of one or more other aircraft components associated with other aircraft. Additionally, or alternatively, an aviation operational feature comprises one or more items of data representative and/or indicative of other aircraft cyber threat events associated with one or more other aircraft. In some embodiments, an aviation operational feature comprises aggregated sensor data from a plurality of aircraft, fleet-wide telemetry data, maintenance records, flight logs, anomaly reports, cyber incident reports from other aircraft, and/or communication patterns across a fleet. In some embodiments, an aviation operational feature is received from an airline operations center, a maintenance provider, a regulatory agency, and/or one or more other cloud-based systems.

As shown in block 604, the method 600 may comprise training the aircraft cyber threat detection model. In some embodiments, the cloud-based aircraft cyber threat operations device 140 is configured to train the aircraft cyber threat detection model using an aviation operational feature. In some embodiments, training the aircraft cyber threat detection model comprises adjusting one or more weights, parameters, and/or coefficients of the aircraft cyber threat detection model based on a training data set. For example, training the aircraft cyber threat detection model may comprise applying a loss function and/or an optimization algorithm to minimize an error between a predicted output and/or an expected output. Additionally, or alternatively, in some embodiments, training the aircraft cyber threat detection model comprises performing one or more training iterations and/or epochs over a training data set. In some embodiments, training the aircraft cyber threat detection model comprises utilizing a training data set, a validation data set, and/or a test data set to evaluate and/or improve a performance of the aircraft cyber threat detection model. In some embodiments, the cloud-based aircraft cyber threat operations device 140 is configured to fine-tune and/or retrain the aircraft cyber threat detection model based on new aviation operational features and/or updated cyber threat information.

As shown in block 606, the method 600 may comprise deploying the aircraft cyber threat detection model. In some embodiments, the cloud-based aircraft cyber threat operations device 140 is configured to deploy the aircraft cyber threat detection model to the onboard aircraft cyber threat operations device 120. For example, the cloud-based aircraft cyber threat operations device 140 may be configured to deploy the aircraft cyber threat detection model to the onboard aircraft cyber threat operations device 120 via the network 130, via a wireless communication link, and/or via a wired connection during ground operations. In some embodiments, the cloud-based aircraft cyber threat operations device 140 may push the aircraft cyber threat detection model to the onboard aircraft cyber threat operations device 120. Additionally, or alternatively, in some embodiments, the onboard aircraft cyber threat operations device 120 may pull and/or request the aircraft cyber threat detection model from the cloud-based aircraft cyber threat operations device 140. In some embodiments, the aircraft cyber threat detection model is deployed as a software update, as a model file, and/or as a set of parameters and/or weights. In some embodiments, the cloud-based aircraft cyber threat operations device 140 is configured to deploy the aircraft cyber threat detection model to the onboard aircraft cyber threat operations device 120 after the cloud-based aircraft cyber threat operations device 140 has trained the aircraft cyber threat detection model. Additionally, or alternatively, in some embodiments, the cloud-based aircraft cyber threat operations device 140 is configured to deploy the aircraft cyber threat detection model prior to an aircraft mission performed by the aircraft 110.

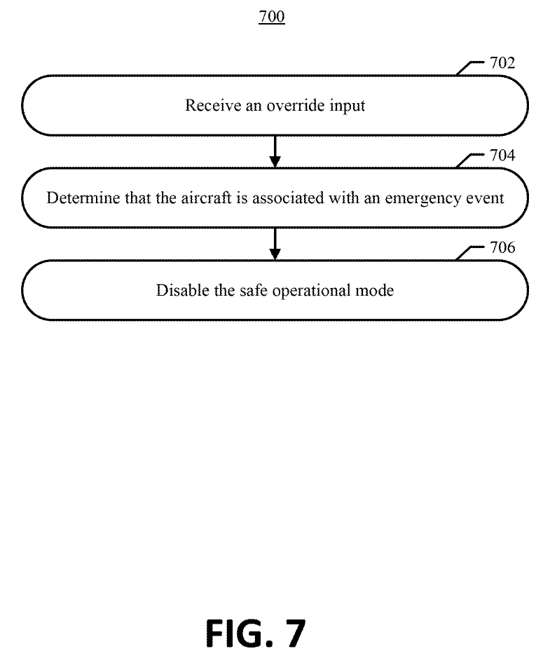

Referring now to FIG. 7, a flowchart providing an example method 700 is illustrated. In this regard, FIG. 7 illustrates operations that may be performed by the aircraft 110, the cloud-based aircraft cyber threat operations device 140, the onboard aircraft cyber threat operations device 120, the one or more user devices 190, the one or more aircraft components 304, the one or more backup aircraft components 306, the aircraft bus 302, and/or the like. In some embodiments, the method 700 comprises operations for disabling a safe operational mode associated with an aircraft component in response to an emergency event. In some embodiments, the example method 700 defines a computer-implemented process, which may be executable by any of the device(s) and/or system(s) embodied in hardware, software, firmware, and/or a combination thereof, as described herein. In some embodiments, computer program code comprising one or more computer-coded instructions are stored to at least one non-transitory computer-readable storage medium, such that execution of the computer program code initiates performance of the method 700.

As shown in block 702, the method 700 may comprise receiving an override input. In some embodiments, when the first aircraft component is in a safe operational mode, the onboard aircraft cyber threat operations device 120 is configured to receive an override input from an operator of the aircraft 110 (e.g., a pilot). For example, the onboard aircraft cyber threat operations device 120 may receive an override input via a user interface, a physical switch, a voice command, and/or a dedicated override control on a flight deck. In some embodiments, the override input comprises an indication from the operator that full functionality of the first aircraft component is desired and/or that the safe operational mode is to be disabled. Additionally, or alternatively, in some embodiments, the override input may be received via the aircraft cyber threat event control interface element 406.

As shown in block 704, the method 700 may comprise determining that the aircraft is associated with an emergency event. In some embodiments, the onboard aircraft cyber threat operations device 120 is configured to determine that the aircraft 110 is associated with an emergency event based on one or more aircraft operational features. For example, the onboard aircraft cyber threat operations device 120 may analyze sensor readings, system status indicators, warning indicators, and/or error codes to determine that an emergency event is occurring. Additionally, or alternatively, in some embodiments, the onboard aircraft cyber threat operations device 120 may determine that an emergency event is occurring based on an altitude measurement, an airspeed measurement, a rate of descent, a proximity to terrain, and/or an engine parameter indicating a malfunction. In some embodiments, the determination that the aircraft 110 is associated with an emergency event may be made in conjunction with receiving the override input from the operator.

As shown in block 706, the method 700 may comprise disabling the safe operational mode. In some embodiments, the onboard aircraft cyber threat operations device 120 is configured to disable safe operational mode associated with the first aircraft component in response to determining that the aircraft 110 is associated with an emergency event. For example, the onboard aircraft cyber threat operations device 120 may transmit a command to the first aircraft component instructing the first aircraft component to exit safe operational mode and/or restore full functionality. Additionally, or alternatively, in some embodiments, the onboard aircraft cyber threat operations device 120 may modify one or more configuration parameters associated with the first aircraft component to re-enable previously disabled operations and/or data paths. In some embodiments, disabling the safe operational mode comprises restoring access to operations such as autopilot disengagement, navigation alteration requests, and/or communication functions that were previously disabled during the safe operational mode.

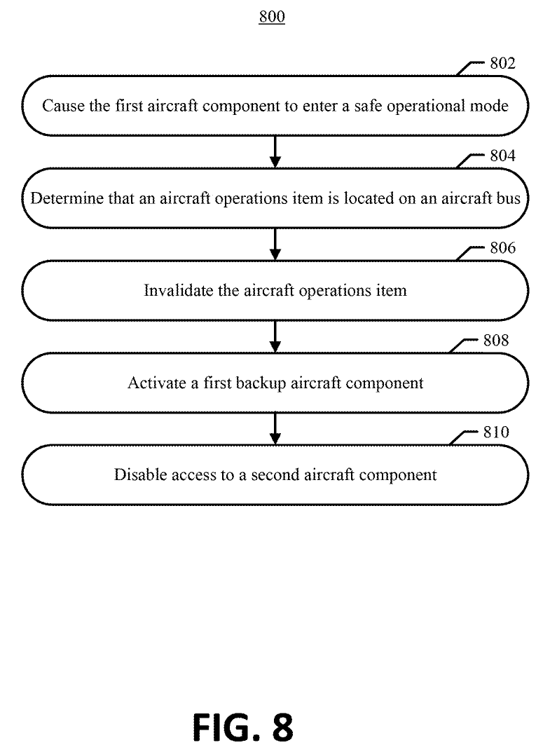

Referring now to FIG. 8, a flowchart providing an example method 800 is illustrated. In this regard, FIG. 8 illustrates operations that may be performed by the aircraft 110, the cloud-based aircraft cyber threat operations device 140, the onboard aircraft cyber threat operations device 120, the one or more user devices 190, the one or more aircraft components 304, the one or more backup aircraft components 306, the aircraft bus 302, and/or the like. In some embodiments, the method 800 comprises operations for performing aircraft cyber threat responsive actions. In some embodiments, the example method 800 defines a computer-implemented process, which may be executable by any of the device(s) and/or system(s) embodied in hardware, software, firmware, and/or a combination thereof, as described herein. In some embodiments, computer program code comprising one or more computer-coded instructions are stored to at least one non-transitory computer-readable storage medium, such that execution of the computer program code initiates performance of the method 800.

As shown in block 802, the method 800 may comprise causing the first aircraft component to enter a safe operational mode. In some embodiments, performing one or more aircraft cyber threat responsive actions comprises causing a first aircraft component (e.g., an aircraft component associated with a cyber threat event) to enter a safe operational mode. In some embodiments, a safe operational mode comprises a restricted operational state, a limited functionality mode, and/or a reduced capability mode. In some embodiments, in a safe operational mode an aircraft component will provide, facilitate, and/or the like operations that enable the aircraft to aviate, navigate, and/or communicate (ANAC). For example, in a safe operational mode operations such as autopilot disengagement, navigation alteration request, communication functions, and/or the like may be disabled. In some embodiments, causing a first aircraft component to enter a safe operational mode comprises sending a command to the first aircraft component. For example, the onboard aircraft cyber threat operations device 120 may transmit a control signal to the first aircraft component instructing the first aircraft component to enter a safe operational mode.

As shown in block 804, the method 800 may comprise determining that an aircraft operations item is located on an aircraft bus. In some embodiments, performing one or more aircraft cyber threat responsive actions comprises determining that a first aircraft operations item is located on the aircraft bus 302. In some embodiments, an aircraft operations item comprises one or more items of data that is generated by an aircraft component associated with a cyber threat event and/or has been provided to the aircraft bus 302. For example, an aircraft operations item may comprise a navigation command, a sensor reading, a control surface command, a communication message, a flight parameter update, a system status message, and/or the like. In some embodiments, the onboard aircraft cyber threat operations device 120 is configured to determine that an aircraft operations item is located on the aircraft bus 302 by monitoring data packets transmitted on the aircraft bus 302. For example, the onboard aircraft cyber threat operations device 120 may analyze data headers, compare data against expected data patterns, and/or identify data originating from an aircraft component associated with a cyber threat event.

As shown in block 806, the method 800 may comprise invalidating the aircraft operations item. In some embodiments, performing one or more aircraft cyber threat responsive actions comprises invalidating the aircraft operations item in response to determining that the aircraft operations item is located on the aircraft bus 302. In some embodiments, invalidating the aircraft operations item comprises applying an invalidation indicator to the aircraft operations item (e.g., indicating that the aircraft operations item is associated with an aircraft cyber threat event) and/or removing the aircraft operations item from the aircraft bus 302. For example, invalidating the aircraft operations item may comprise setting a flag associated with the aircraft operations item, modifying a status field of the aircraft operations item, broadcasting an invalidation message to other aircraft components 304, overwriting the aircraft operations item, and/or preventing other aircraft components 304 from reading the aircraft operations item. In some embodiments, after invalidating the aircraft operations item, other aircraft components 304 and/or backup aircraft components 306 are configured to ignore the invalidated aircraft operations item.

As shown in block 808, the method 800 may comprise activating a first backup aircraft component. In some embodiments, performing one or more aircraft cyber threat responsive actions comprises activating a first backup aircraft component corresponding to the first aircraft component. In this regard, in some embodiments, the first backup aircraft component may be configured to perform the functionalities of the first aircraft component when the first aircraft component is in a safe operational mode. For example, a first backup aircraft component may comprise a backup flight management system, a backup navigation system, a backup communication system, a backup autopilot system, a backup flight control computer, and/or the like. In some embodiments, activating a first backup aircraft component comprises sending an activation command to the first backup aircraft component. Additionally, or alternatively, in some embodiments, activating a first backup aircraft component comprises switching one or more data paths on the aircraft bus 302 from the first aircraft component to the first backup aircraft component. For example, the onboard aircraft cyber threat operations device 120 may redirect data flow on the aircraft bus 302 such that other aircraft components 304 receive data from the first backup aircraft component instead of the first aircraft component.

As shown in block 810, the method 800 may comprise disabling access to a second aircraft component. In some embodiments, performing one or more aircraft cyber threat responsive actions comprises disabling access to a second aircraft component of the one or more aircraft components by a computing agent (e.g., a computing agent associated with an aircraft cyber threat event). In some embodiments, the second aircraft component comprises a flight management system. Additionally, or alternatively, in some embodiments, the second aircraft component comprises an autopilot system, a navigation display, a communication system, a flight control computer, and/or the like. In some embodiments, disabling access to a second aircraft component comprises revoking one or more authentication credentials associated with the computing agent. Additionally, or alternatively, in some embodiments, disabling access to a second aircraft component comprises blocking one or more network connections and/or communication links associated with the computing agent. For example, the onboard aircraft cyber threat operations device 120 may terminate one or more active sessions between the computing agent and/or the second aircraft component. In some embodiments, disabling access to a second aircraft component comprises modifying one or more access control lists and/or permission settings associated with the second aircraft component. For example, the onboard aircraft cyber threat operations device 120 may update a firewall rule, a security policy, and/or an access control configuration to prevent the computing agent from accessing the second aircraft component.

### Adiitional Example Embodiments

Hereinafter, various characteristics of certain example embodiments will be highlighted in a set of numbered clauses or paragraphs. These characteristics are not to be interpreted as being limiting on the invention or inventive concept, but are provided merely as a recitation of some characteristics as described herein, without suggesting a particular order of importance or relevancy of such example characteristics.

Clause 1. A method comprising: receiving, at an onboard aircraft cyber threat operations device, an aircraft cyber threat detection model from a cloud-based aircraft cyber threat operations device, wherein the aircraft cyber threat detection model is trained by the cloud-based aircraft cyber threat operations device; identifying, using the onboard aircraft cyber threat operations device, an aircraft operational feature from a first aircraft component of one or more aircraft components of an aircraft, wherein the aircraft operational feature is representative of operations of the first aircraft component while the aircraft is performing an aircraft mission; detecting, using the onboard aircraft cyber threat operations device, an aircraft cyber threat event by applying the aircraft operational feature to the aircraft cyber threat detection model; and performing, using the onboard aircraft cyber threat operations device and based on the aircraft cyber threat event, one or more aircraft cyber threat responsive actions.

Clause 2. The method of Clause 1, wherein the aircraft cyber threat event is detected during a cruise phase of the aircraft mission.

Clause 3. The method of any of Clauses 1-2, wherein the aircraft cyber threat event comprises access of the first aircraft component by a computing agent, wherein the computing agent is not authorized to access the first aircraft component.

Clause 4. The method of any of Clauses 1-3, wherein the first aircraft component comprises a line replaceable unit.

Clause 5. The method of any of Clauses 1-4, further comprising: receiving, at the cloud-based aircraft cyber threat operations device, an aviation operational feature, wherein the aviation operational feature is representative of operations of a second aircraft; training, using the cloud-based aircraft cyber threat operations device and based on the aviation operational feature, the aircraft cyber threat detection model; and deploying, using the cloud-based aircraft cyber threat operations device, the aircraft cyber threat detection model to the onboard aircraft cyber threat operations device.

Clause 6. The method of any of Clauses 1-5, wherein the first aircraft component is in a safe operational mode and the method further comprises: receiving an override input from an operator of the aircraft; determining that the aircraft is associated with an emergency event based on one or more aircraft operational features; and disabling the safe operational mode associated with the first aircraft component in response to determining that the aircraft is associated with the emergency event.

Clause 7. The method of any of Clauses 1-6, wherein performing the one or more aircraft cyber threat responsive actions comprises: causing the first aircraft component to enter a safe operational mode.

Clause 8. The method of any of Clauses 1-7, wherein performing the one or more aircraft cyber threat responsive actions comprises: determining that an aircraft operations item is located on an aircraft bus, wherein the aircraft operations item was provided to the aircraft bus by the first aircraft component; and invalidating the aircraft operations item in response to determining that the aircraft operations item is located on the aircraft bus, wherein invalidating the aircraft operations item comprises applying an invalidation indicator to the aircraft operations item and/or removing the aircraft operations item from the aircraft bus.

Clause 9. The method of any of Clauses 1-8, wherein performing the one or more aircraft cyber threat responsive actions comprises: activating a first backup aircraft component corresponding to the first aircraft component.

Clause 10. The method of any of Clauses 1-9, wherein performing the one or more aircraft cyber threat responsive actions comprises: disabling access to a second aircraft component by a computing agent, wherein the second aircraft component comprises a flight management system of the aircraft.

Clause 11. An apparatus comprising memory and one or more processors communicatively coupled to the memory, the one or more processors configured to perform operations comprising: receiving, at an onboard aircraft cyber threat operations device, an aircraft cyber threat detection model from a cloud-based aircraft cyber threat operations device, wherein the aircraft cyber threat detection model is trained by the cloud-based aircraft cyber threat operations device; identifying, using the onboard aircraft cyber threat operations device, an aircraft operational feature from a first aircraft component of one or more aircraft components of an aircraft, wherein the aircraft operational feature is representative of operations of the first aircraft component while the aircraft is performing an aircraft mission; detecting, using the onboard aircraft cyber threat operations device, an aircraft cyber threat event by applying the aircraft operational feature to the aircraft cyber threat detection model; and performing, using the onboard aircraft cyber threat operations device and based on the aircraft cyber threat event, one or more aircraft cyber threat responsive actions.

Clause 12. The apparatus of Clause 11, wherein the aircraft cyber threat event is detected during a cruise phase of the aircraft mission.

Clause13. The apparatus of any of Clauses 11-12, wherein the aircraft cyber threat event comprises access of the first aircraft component by a computing agent, wherein the computing agent is not authorized to access the first aircraft component, wherein the first aircraft component comprises a line replaceable unit.

Clause 14. The apparatus of any of Clauses 11-13, wherein the operations further comprise: receiving, at the cloud-based aircraft cyber threat operations device, an aviation operational feature, wherein the aviation operational feature is representative of operations of a second aircraft; training, using the cloud-based aircraft cyber threat operations device and based on the aviation operational feature, the aircraft cyber threat detection model; and deploying, using the cloud-based aircraft cyber threat operations device, the aircraft cyber threat detection model to the onboard aircraft cyber threat operations device.

Clause 15. The apparatus of any of Clauses 11-14, wherein the first aircraft component is in a safe operational mode and the operations further comprise: receiving an override input from an operator of the aircraft; determining that the aircraft is associated with an emergency event based on one or more aircraft operational features; and disabling the safe operational mode associated with the first aircraft component in response to determining that the aircraft is associated with the emergency event.

Clause 16. The apparatus of any of Clauses 11-15, wherein performing the one or more aircraft cyber threat responsive actions comprises: causing the first aircraft component to enter a safe operational mode.

Clause 17. The apparatus of any of Clauses 11-16, wherein performing the one or more aircraft cyber threat responsive actions comprises: determining that an aircraft operations item is located on an aircraft bus, wherein the aircraft operations item was provided to the aircraft bus by the first aircraft component; and invalidating the aircraft operations item in response to determining that the aircraft operations item is located on the aircraft bus, wherein invalidating the aircraft operations item comprises applying an invalidation indicator to the aircraft operations item and/or removing the aircraft operations item from the aircraft bus.

Clause 18. The apparatus of any of Clauses 11-17, wherein performing the one or more aircraft cyber threat responsive actions comprises: activating a first backup aircraft component corresponding to the first aircraft component.

Clause 19. The apparatus of any of Clauses 11-18, wherein performing the one or more aircraft cyber threat responsive actions comprises: disabling access to a second aircraft component by a computing agent, wherein the second aircraft component comprises a flight management system of the aircraft.

Clause 20. A computer program product comprising at least one non-transitory computer-readable storage medium having computer program code stored thereon that, in execution with at least one processor, configures the computer program product for: receiving, at an onboard aircraft cyber threat operations device, an aircraft cyber threat detection model from a cloud-based aircraft cyber threat operations device, wherein the aircraft cyber threat detection model is trained by the cloud-based aircraft cyber threat operations device; identifying, using the onboard aircraft cyber threat operations device, an aircraft operational feature from a first aircraft component of one or more aircraft components of an aircraft, wherein the aircraft operational feature is representative of operations of the first aircraft component while the aircraft is performing an aircraft mission; detecting, using the onboard aircraft cyber threat operations device, an aircraft cyber threat event by applying the aircraft operational feature to the aircraft cyber threat detection model; and performing, using the onboard aircraft cyber threat operations device and based on the aircraft cyber threat event, one or more aircraft cyber threat responsive actions.

### CONCLUSION

While this specification contains many specific implementation details, these should not be construed as limitations on the scope of any disclosures or of what may be claimed, but rather as descriptions of features specific to particular embodiments of particular disclosures. Certain features described herein in the context of separate embodiments can also be implemented in combination in a single embodiment. Conversely, various features described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination. Similarly, while operations are depicted in the drawings in a particular order, this should not be understood as requiring that such operations be performed in the particular order shown or in sequential order, or that all illustrated operations be performed, to achieve desirable results.

In certain circumstances, multitasking and parallel processing may be advantageous. The separation of various system components in the embodiments described above should not be understood as requiring such separation in all embodiments, and it should be understood that the described program components and systems can generally be integrated together in a single software product or packaged into multiple software products. Particular embodiments of the subject matter have been described. Other embodiments are within the scope of the following claims. The actions recited in the claims can in some cases be performed in a different order and still achieve desirable results. The processes depicted in the accompanying figures do not necessarily require the particular order shown, or sequential order, to achieve desirable results.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems may generally be integrated together in a product or packaged into multiple products.

Thus, particular embodiments of the subject matter have been described. Other embodiments are within the scope of the following claims. In some cases, the actions recited in the claims may be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

1. A method comprising:
receiving, at an onboard aircraft cyber threat operations device, an aircraft cyber threat detection model from a cloud-based aircraft cyber threat operations device, wherein the aircraft cyber threat detection model is trained by the cloud-based aircraft cyber threat operations device;
identifying, using the onboard aircraft cyber threat operations device, an aircraft operational feature from a first aircraft component of one or more aircraft components of an aircraft, wherein the aircraft operational feature is representative of operations of the first aircraft component while the aircraft is performing an aircraft mission;
detecting, using the onboard aircraft cyber threat operations device, an aircraft cyber threat event by applying the aircraft operational feature to the aircraft cyber threat detection model; and
performing, using the onboard aircraft cyber threat operations device and based on the aircraft cyber threat event, one or more aircraft cyber threat responsive actions.

2. The method of claim 1, wherein the aircraft cyber threat event is detected during a cruise phase of the aircraft mission.

3. The method of claim 1, wherein the aircraft cyber threat event comprises access of the first aircraft component by a computing agent, wherein the computing agent is not authorized to access the first aircraft component.

4. The method of claim 1, wherein the first aircraft component comprises a line replaceable unit.

5. The method of claim 1, further comprising:
receiving, at the cloud-based aircraft cyber threat operations device, an aviation operational feature, wherein the aviation operational feature is representative of operations of a second aircraft;
training, using the cloud-based aircraft cyber threat operations device and based on the aviation operational feature, the aircraft cyber threat detection model; and
deploying, using the cloud-based aircraft cyber threat operations device, the aircraft cyber threat detection model to the onboard aircraft cyber threat operations device.

6. The method of claim 1, wherein the first aircraft component is in a safe operational mode and the method further comprises:
receiving an override input from an operator of the aircraft;
determining that the aircraft is associated with an emergency event based on one or more aircraft operational features; and
disabling the safe operational mode associated with the first aircraft component in response to determining that the aircraft is associated with the emergency event.

7. The method of claim 1, wherein performing the one or more aircraft cyber threat responsive actions comprises:
causing the first aircraft component to enter a safe operational mode.

8. The method of claim 1, wherein performing the one or more aircraft cyber threat responsive actions comprises:
determining that an aircraft operations item is located on an aircraft bus, wherein the aircraft operations item was provided to the aircraft bus by the first aircraft component; and
invalidating the aircraft operations item in response to determining that the aircraft operations item is located on the aircraft bus, wherein invalidating the aircraft operations item comprises applying an invalidation indicator to the aircraft operations item or removing the aircraft operations item from the aircraft bus.

9. The method of claim 1, wherein performing the one or more aircraft cyber threat responsive actions comprises:
activating a first backup aircraft component corresponding to the first aircraft component.

10. The method of claim 1, wherein performing the one or more aircraft cyber threat responsive actions comprises:
disabling access to a second aircraft component by a computing agent, wherein the second aircraft component comprises a flight management system of the aircraft.

11. An apparatus comprising memory and one or more processors communicatively coupled to the memory, the one or more processors configured to perform operations comprising:
receiving, at an onboard aircraft cyber threat operations device, an aircraft cyber threat detection model from a cloud-based aircraft cyber threat operations device, wherein the aircraft cyber threat detection model is trained by the cloud-based aircraft cyber threat operations device;
identifying, using the onboard aircraft cyber threat operations device, an aircraft operational feature from a first aircraft component of one or more aircraft components of an aircraft, wherein the aircraft operational feature is representative of operations of the first aircraft component while the aircraft is performing an aircraft mission;
detecting, using the onboard aircraft cyber threat operations device, an aircraft cyber threat event by applying the aircraft operational feature to the aircraft cyber threat detection model; and
performing, using the onboard aircraft cyber threat operations device and based on the aircraft cyber threat event, one or more aircraft cyber threat responsive actions.

12. The apparatus of claim 11, wherein the aircraft cyber threat event is detected during a cruise phase of the aircraft mission.

13. The apparatus of claim 11, wherein the aircraft cyber threat event comprises access of the first aircraft component by a computing agent, wherein the computing agent is not authorized to access the first aircraft component, wherein the first aircraft component comprises a line replaceable unit.

14. The apparatus of claim 11, wherein the operations further comprise:
receiving, at the cloud-based aircraft cyber threat operations device, an aviation operational feature, wherein the aviation operational feature is representative of operations of a second aircraft;
training, using the cloud-based aircraft cyber threat operations device and based on the aviation operational feature, the aircraft cyber threat detection model; and
deploying, using the cloud-based aircraft cyber threat operations device, the aircraft cyber threat detection model to the onboard aircraft cyber threat operations device.

15. The apparatus of claim 11, wherein the first aircraft component is in a safe operational mode and the operations further comprise:
receiving an override input from an operator of the aircraft;
determining that the aircraft is associated with an emergency event based on one or more aircraft operational features; and
disabling the safe operational mode associated with the first aircraft component in response to determining that the aircraft is associated with the emergency event.

16. The apparatus of claim 11, wherein performing the one or more aircraft cyber threat responsive actions comprises:
causing the first aircraft component to enter a safe operational mode.

17. The apparatus of claim 11, wherein performing the one or more aircraft cyber threat responsive actions comprises:
determining that an aircraft operations item is located on an aircraft bus, wherein the aircraft operations item was provided to the aircraft bus by the first aircraft component; and
invalidating the aircraft operations item in response to determining that the aircraft operations item is located on the aircraft bus, wherein invalidating the aircraft operations item comprises applying an invalidation indicator to the aircraft operations item or removing the aircraft operations item from the aircraft bus.

18. The apparatus of claim 11, wherein performing the one or more aircraft cyber threat responsive actions comprises:
activating a first backup aircraft component corresponding to the first aircraft component.

19. The apparatus of claim 11, wherein performing the one or more aircraft cyber threat responsive actions comprises:
disabling access to a second aircraft component by a computing agent, wherein the second aircraft component comprises a flight management system of the aircraft.

20. A computer program product comprising at least one non-transitory computer-readable storage medium having computer program code stored thereon that, in execution with at least one processor, configures the computer program product for:
receiving, at an onboard aircraft cyber threat operations device, an aircraft cyber threat detection model from a cloud-based aircraft cyber threat operations device, wherein the aircraft cyber threat detection model is trained by the cloud-based aircraft cyber threat operations device;
identifying, using the onboard aircraft cyber threat operations device, an aircraft operational feature from a first aircraft component of one or more aircraft components of an aircraft, wherein the aircraft operational feature is representative of operations of the first aircraft component while the aircraft is performing an aircraft mission;
detecting, using the onboard aircraft cyber threat operations device, an aircraft cyber threat event by applying the aircraft operational feature to the aircraft cyber threat detection model; and
performing, using the onboard aircraft cyber threat operations device and based on the aircraft cyber threat event, one or more aircraft cyber threat responsive actions.
